(19) United States
(12) Patent Application Publication
(10) Pub. No.: US 2006/0083830 A1
(43) Pub. Date: Apr. 20, 2006

(54) Polylysine-containing food additive and acidic adjuvant

(75) Inventors: Maurice C. Kemp, Lincoln, CA (US); Zhong Wei Xie, Folsom, CA (US)

Correspondence Address: T. Ling Chwang, Suite 600, 2435 N. Central Expressway, Richardson, TX, 75080, US

(73) Assignee: Mionix Corporation, Rocklin, CA (US)

(21) Appl. No.: 11/251,666

(22) Filed: Oct. 17, 2005

Related U.S. Application Data
(60) Provisional application No. 60/620,046, filed on Oct. 19, 2004.

(51) Int. Cl. A23L 3/3463

(52) U.S. Cl. 426/335

(57) ABSTRACT

A food additive composition comprising ε-polylysine in higher than normal concentrations and optionally in combination with an acidic adjuvant. The acidic adjuvant may be a low pH solution of sparingly-soluble Group IIA-complexes (“AGIIS”), a highly acidic metalated organic acid (“HAMO”), or a highly acidic metalated mixture of inorganic acids (“HAMMIA”). The food additive composition is an effective bacteriostatic preservative against pathogenic microorganisms which may be present in food products. Blending food products such as ground meats and flour-based products with the food additive with or without an acidic adjuvant causes a reduction in the number of detectable microbes for an extended period of time.

### BACKGROUND

This application claims priority to U.S. Provisional Patent Application, Ser. No. 60/620,046, entitled “POLYLYSINE-CONTAINING FOOD ADDITIVE AND ACIDIC ADJUVANT” filed on Oct. 19, 2004, the entire content of which is hereby incorporated by reference.

This invention relates to a food additive composition for inhibiting the growth of pathogenic microorganisms on food products and its method of use. In particular, the food additive composition comprises ε-polylysine and a combination of the ε-polylysine with an acidic adjuvant.

Eliminating microbial pathogens from food products is currently a matter of significant public health concern. Harmful microbial organisms which may be present in meat products include Staphylococcus, Campylobacter jejuni, Salmonella, Clostridium perfringes, Toxoplasma gondii, and Botulism. Three organisms in particular pose immediate risks: Escherichia coli, Listeria monocytogenes, and Salmonella typhimurium.

Escherichia coli is a bacterium naturally found in the intestinal tracts of animals and humans. One particular rare strain, E. coli O157:H7, is a member of the enterohemorrhagic E. coli group. This strain of bacteria produces the Shiga-like toxin, or as it is sometimes called, Vero toxin. The toxin is a protein which causes severe damage to intestinal epithelial cells, leading to the loss of water and salts, damage to blood vessels, and hemorrhaging. In some cases hemolytic uremic syndrome occurs, which is characterized by kidney failure and loss of red blood cells. In severe cases, the disease can cause permanent kidney damage. E. coli O157:H7 is particularly dangerous to small children, the elderly, and the infirm. An estimated 73,000 cases of infection and 61 deaths occur in the United States each year. Most illness has been associated with eating undercooked, contaminated ground beef.

Listeria monocytogenes is a foodborne pathogen of significant public health concern due to its virulence in susceptible individuals, and as a consequence has received a presidential mandate for reduction to decrease the incidence of foodborne illness. L. monocytogenes is a facultative, intracellular gram-positive, nonsporeforming and psychrotrophic bacterium that causes the disease called listeriosis. Immunocompromised individuals, infants, pregnant women and elderly persons are the most at risk. Listeriosis can cause high fever, severe headache, neck stiffness and nausea. In humans, the primary manifestations of listeriosis are meningitis, abortion and prenatal septicemia. The estimated annual incidence of listeriosis in the United States is 1850 cases resulting in 425 deaths. Although foodborne listeriosis is rare, the associated mortality rate is as high as 20% among those at risk. The infectious dose of L. monocytogenes is unknown. It is an ubiquitous organism able to survive and multiply at refrigeration temperatures in the presence or absence of oxygen, and can tolerate a range of pHs and concentrations of up to 12-13% salt. Moreover, some strains may grow at a water activity (a_{w}) as low as 0.9 and at a pH value as low as 4.4 (Walker et al., J. App. Bacteriol., vol. 68, pp. 157-62, 1990; Farber and Peterkin, Microbiol. Rev., vol. 55, pp. 476-511, 1991; Miller, J. Food Prot., vol. 55, pp. 414-18, 1992).

Salmonella is one of the most common enteric (intestinal) infections in the U.S. Salmonella species are Gram-negative, flagellated facultatively anaerobic bacilli. There is a widespread occurrence of Salmonella bacteria in animals, especially in poultry and swine. Environmental sources of the organism include water, soil, insects, factory surfaces, kitchen surfaces, animal feces, raw meats, raw poultry, and raw seafoods. Salmonellosis ranges clinically from the common Salmonella gastroenteritis (diarrhea, abdominal cramps, and fever) to enteric fevers (including typhoid fever) which are life-threatening febrile systemic illness requiring prompt antibiotic therapy. The acute symptoms of Salmonella gastroenteritis include the sudden onset of nausea, abdominal cramping, and bloody diarrhea with mucous. The onset of symptoms usually occurs within 6 to 72 hours after the ingestion of the bacteria. The infectious dose is small, probably from 15 to 20 cells. There is no real cure for a Salmonella infection, except treatment of the symptoms. For most strains of Salmonella, the fatality rate is less than one percent.

The U.S. Department of Agriculture—Food Safety Inspection Service (“USDA-FSIS”) issues regulations establishing pathogen reduction requirements applicable to meat establishments. These are designed to reduce the occurrence and numbers of pathogens in meat and poultry products, thus reducing the risk of food-borne disease. The principal source of transmission of pathogens is from the hides of animals arriving at processing plants, or carcasses that become cross-contaminated with intestinal contents during processing. In ready-to-eat (“RTE”) products, cross-contamination or re-contamination by pathogens in the processing plant, such as through human handling or contaminated processing equipment, is a major concern (Borch and Arinder, 2002). Recontamination of cooked products can, in fact, result in a more serious problem for decontamination than untreated products, especially for spore-forming microbes like Clostridium or cold-tolerant, psychotrophic bacteria such as Listeria, because of a lack of competing microflora. Listeriosis acquired from the consumption of RTE products represents a serious public health concern because of the high mortality rates associated with the illness. However, contamination of raw materials by Listeria can also be a problem, especially in a small plant. Many small processors deal with both raw and processed products, often in close proximity, which increase the prospects of cross-contamination unless proper measures are implemented and strictly enforced.

A wide variety of approaches to sanitize meat or poultry products after harvesting include, in part, cold and hot water rinses, steam pasteurization or steam vacuum treatment, trimming, chemical rinses, and organic acid rinses with or without surfactants (Conner, 2001; Huffman, 2002; Mermelstein, 2001; White, 2002). In addition, antimicrobial compounds may be added to many RTE products, including sodium or potassium lactate, sodium diacetate, sodium citrate, and antioxidant compounds such as spices, extracts, fruit preparations, or synthetic antioxidants. Most of these individually will provide only a 0.5-3 log reduction in microbes, with water rinses being the least effective. A time lag between treatment of the carcass or trim materials also can allow bacterial attachment to occur, which decreases the effectiveness of most washing procedures.

The most commonly used chemical decontamination methods are rinses containing chlorine, chlorine dioxide, acidified sodium chlorite, electrolyzed water, ozone, trisodium phosphate (TSP) and cetylpyridinium chloride (“CPC”). The “gaseous” antimicrobials, including chlorine, chlorine dioxide, and ozone, usually are applied as an aqueous solution and generally have resulted in about a 2-4 log reduction of pathogens depending on concentration, temperature of application and contact time. The effects tend to be transient, providing no extended bactericidal/bacteristatic effect after treatment. The primary reason is that these compounds are readily reactive with unsaturated bonds, thus quickly removing them from solution and negating further action against bacterial cells. TSP, on the other hand, is an alkaline salt solution which can leave residual reactive hydroxyl radicals on the treated product and suppress further growth. It has been found to improve the color of the meat product, but the treatment also generates large amounts of phosphates, which can be environmentally harsh and create a problem for disposal.

The use of organic acids as a carcass washing intervention is frequently employed, with the most commonly used acids being lactic and acetic. Both acids are considered “generally recognized as safe” (“GRAS”) for use in the food industry. Lactic and acetic acids also tend to offer the best residual efficacy for suppression of further pathogen proliferation during both long-term refrigerated storage or short-term temperature abuse conditions. The rinse concentrations used are usually 2-5% and both acids are most effective if applied immediately after a hot water wash or as heated solutions, usually at about 55° C. While these applications are both cheap and effective, the treated product can acquire an undesirable color, loss of ground emulsion stability, and increased acidic flavor if the residual is too high.

### SUMMARY

The current invention pertains to a food additive composition comprising ε-polylysine in higher than normal concentrations, optionally in combination with an acidic adjuvant. The food additive composition effectively reduces pathogens in food products and prevents pathogenic outgrowth.

ε-Polylysine is a straight-chain polyamino acid in which the carboxyl group is linked to the E-amino group of L-lysine, an essential amino acid. Only this substance and γ-polyglutamic acid are naturally occurring amino acid polymers. The systematic name of ε-polylysine is poly(imino(2-amino-1-oxo-1,6-hexanediyl)). ε-Polylysine is prepared from a fermentation process using Streptomyces albulus under aerobic conditions. The process for producing ε-polylysine is described in U.S. Pat. No. 5,900,363, the entire content of which is hereby incorporated by reference. ε-Polylysine shows a wide antimicrobial spectrum, and the minimum inhibitory concentration (“MIC”) for the growth of many bacteria is indicated as below 100 μg mL⁻¹ (Shima et al., 1984; Hiraki, 2000).

ε-Polylysine is applied in practical circumstances as a food additive on the basis of its strong antimicrobial activity (Hiraki, 2000). Its safety as a food additive has been confirmed by experiments conducted in rats, showing the additive to have no adverse reproductive toxological effects, nor to affect neurological and immunological function, embryonic and fetal development and growth of offspring, and the development of embryos or fetuses for two generations (Neda et al., 1999). However, it is considered to result in a bitter taste if added in large quantities (Yoshida et al., 2002).

One embodiment of the food additive can be prepared by blending ε-polylysine in higher than normal concentrations with a food product to produce a food product having reduced microbial activity and outgrowth. An additional embodiment can be prepared by further adding an acidic adjuvant to the food additive composition. The acidic adjuvant may comprise a low pH solution of sparingly-soluble Group IIA-complexes (“AGIIS”), a highly acidic metalated organic acid (“HAMO”), or a highly acidic metalated mixture of inorganic acids (“HAMMIA”), optionally with one or more additives.

### DETAILED DESCRIPTION OF PREFERRED EMBODIMENTS

One aspect of the present invention pertains to a food additive composition which contains ε-polylysine and a method for applying the food additive composition in which the ε-polylysine is distributed throughout the food product. The ε-polylysine is blended with a food product at a higher than normal concentration to effectively reduce the present number of pathogens, as well as suppress their future outgrowth. In another aspect of the present invention, the food product is treated with ε-polylysine and an acidic adjuvant to reduce pathogens in the food product.

Preferably, the ε-polylysine is blended with the food product in a higher than normal concentration. The ε-polylysine may be blended into the food product to a final concentration of from about 100 ppm to about 10,000 ppm, more preferably from about 1000 ppm to about 6000 ppm, and most preferably from about 3000 ppm to about 4000 ppm.

An acidic adjuvant which may be used in the current food additive composition includes any food grade acidulant which does not adversely affect the taste of the food. Preferred examples of the acidic adjuvant include (1) a low pH solution of sparingly-soluble Group IIA-complexes (“AGIIS”); (2) a highly acidic metalated organic acid (“HAMO”); and (3) a highly acidic metalated mixture of inorganic acids (“HAMMIA”). The food additive composition, with or without an acidic adjuvant, may also contain one or more additives. These additives include organic acids, amino acids, alcohols, and surfactants.

In one preferred embodiment, the food additive composition contains an acidic or low pH solution of sparingly-soluble Group IIA complexes (“AGIIS”), which may have a suspension of very fine particles, as an acidic adjuvant. The term “low pH” means the pH is below 7, in the acidic region. The AGIIS has a certain acid normality but does not have the same dehydrating behavior as a saturated calcium sulfate in sulfuric acid having the same normality. In other words, the AGIIS has a certain acid normality but does not char sucrose as readily as does a saturated solution of calcium sulfate in sulfuric acid having the same normality. Further, the AGIIS has low volatility at room temperature and pressure. It is less corrosive to human skin than sulfuric acid saturated with calcium sulfate having the same acid normality. Not intending to be bound by the theory, it is believed that one embodiment of AGIIS comprises near-saturated, saturated, or super-saturated calcium, sulfate anions or variations thereof, and/or complex ions containing calcium, sulfates, and/or variations thereof.

The term “complex,” as used herein, denotes a composition wherein individual constituents are associated. “Associated” means constituents are bound to one another either covalently or non-covalently, the latter as a result of hydrogen bonding or other inter-molecular forces. The constituents may be present in ionic, non-ionic, hydrated or other forms.

The AGIIS can be prepared in several ways. Some of the methods involve the use of Group IA hydroxide but some of syntheses are devoid of the use of any added Group IA hydroxide, although it is possible that a small amount of Group IA metal may be present as “impurities.” The preferred way of manufacturing AGIIS is not to add Group IA hydroxide to the mixture. As the phrase implies, AGIIS is highly acidic, ionic, with a pH of below about 7, preferably below about 2. See, “Acidic Solution of Sparingly-Soluble Group IIA Complexes,” U.S. application Ser. No. 09/500,473, filed Feb. 9, 2000, the entire content of which is hereby incorporated by reference. See also, “Highly Acidic Metalated Organic Acid as a Food Additive,” U.S. application Ser. No. 09/766,546, filed Jan. 19, 2001, the entire content of which is hereby incorporated by reference.

A preferred method of preparing AGIIS involves mixing a mineral acid with a Group IIA hydroxide, or with a Group IIA salt of a dibasic acid, or with a mixture of the two Group IIA materials. In the mixing, a salt of Group IIA is also formed. Preferably, the starting Group IIA material or materials selected will give rise to, and form, the Group IIA salt or salts that are sparingly soluble in water. The preferred mineral acid is sulfuric acid, the preferred Group IIA hydroxide is calcium hydroxide, and the prefer Group IIA salt of a dibasic acid is calcium sulfate. Other examples of Group IIA salt include calcium oxide, calcium carbonate, and “calcium bicarbonate.”

Thus, for example, AGIIS can be prepared by mixing or blending starting materials given in one of the following scheme with good reproducibility:
(1) H₂SO₄ and Ca(OH)₂;
(2) H₂SO₄, Ca(OH)₂, and CaCO₃;
(3) H₂SO₄, Ca(OH)₂, CaCO₃, and CO₂ (gas);
(4) H₂SO₄, CaCO₃, and Ca(OH)₂;
(5) H₂SO₄, Ca(OH)₂, and CaSO₄;
(6) H₂SO₄, CaSO₄, CaCO₃, and Ca(OH)₂;
(7) H₂SO₄, CaSO₄, CaCO₃, and CO₂ (gas); and
(8) H₂SO₄, CaSO₄, CaCO₃, CO₂ (gas), and Ca(OH)₂.

Preferably, AGIIS is prepared by mixing calcium hydroxide with concentrated sulfuric acid, with or without an optional Group IIA salt of a dibasic acid (such as calcium sulfate) added to the sulfuric acid. The optional calcium sulfate can be added to the concentrated sulfuric acid prior to the introduction of calcium hydroxide into the blending mixture. The addition of calcium sulfate to the concentrated sulfuric acid appears to reduce the amount of calcium hydroxide needed for the preparation of AGIIS. Other optional reactants include calcium carbonate and gaseous carbon dioxide being bubbled into the mixture. Regardless of the use of any optional reactants, it was found that the use of calcium hydroxide is desirable.

One preferred method of preparing AGIIS can be described briefly as: Concentrated sulfuric acid is added to chilled water (8°-12° C.) in the reaction vessel, then, with stirring, calcium sulfate is added to the acid in chilled water to give a mixture. Temperature control is paramount to this process. To this stirring mixture is then added a slurry of calcium hydroxide in water. The solid formed from the mixture is then removed. This method involves the use of sulfuric acid, calcium sulfate, and calcium hydroxide, and it has several unexpected advantages. Firstly, this reaction is not violent and is not exceedingly exothermic. Besides being easy to control and easy to reproduce, this reaction uses ingredients each of which has been reviewed by the U.S. Food and Drug Administration (“U.S. FDA”) and determined to be “Generally Recognized As Safe” (“GRAS”). As such, each of these ingredients can be added directly to food, subject, of course, to certain limitations. Under proper concentration, each of these ingredients can be used as processing aids and in food contact applications. Their use is limited only by product suitability and current Good Manufacturing Practices (“cGMP”). The AGIIS so prepared is thus safe for animal consumption, safe for processing aids, and safe in food contact applications. Further, the AGIIS reduces biological contaminants in not only inhibiting the growth of, and killing, microorganisms but also destroying the toxins formed and generated by the microorganisms. The AGIIS formed can also preserve, or extend the shelf-life of, consumable products, be they plant, animal, pharmaceutical, or biological products. It also preserves or improves the organoleptic quality of a beverage, a plant product or an animal product. It also possesses certain healing and therapeutic properties.

The sulfuric acid used is usually 95-98% FCC Grade (about 35-37 N). The amount of concentrated sulfuric acid can range from about 0.05 M to about 18 M (about 0.1 N to about 36 N ), preferably from about 1 M to about 5 M . It is application specific. The term “M” used denotes molar or moles per liter.

Normally, a slurry of finely ground calcium hydroxide suspended in water (about 50% of w/v) is the preferred way of introducing the calcium hydroxide, in increments, into the stirring solution of sulfuric acid, with or without the presence of calcium sulfate. Ordinarily, the reaction is carried out below 40° C., preferably below room temperature, and more preferably below 10° C. The time to add calcium hydroxide can range from about 1 hour to about 4 hours. The agitation speed can vary from about 600 to about 700 rpm or higher. After the mixing, the mixture is filtered through a 5 micron filter. The filtrate is then allowed to sit overnight and the fine sediment is removed by decantation.

The calcium hydroxide used is usually FCC Grade of about 98% purity. For every mole of concentrated acid, such as sulfuric acid, the amount, in mole, of calcium hydroxide used is application specific and ranges from about 0.1 to about 1.

The optional calcium carbonate is normally FCC Grade having a purity of about 98%. When used with calcium hydroxide as described above, for every mole of concentrated acid, such as sulfuric acid, the amount, in mole, of calcium carbonate ranges from about 0.001 to about 0.2, depending on the amount of calcium hydroxide used.

The optional carbon dioxide is usually bubbled into the slurry containing calcium hydroxide at a speed of from about 1 to about 3 pounds pressure. The carbon dioxide is bubbled into the slurry for a period of from about 1 to about 3 hours. The slurry is then added to the reaction vessel containing the concentrated sulfuric acid.

Another optional ingredient is calcium sulfate, a Group IIA salt of a dibasic acid. Normally, dihydrated calcium sulfate is used. As used in this application, the phrase “calcium sulfate,” or the formula “CaSO₄,” means either anhydrous or hydrated calcium sulfate. The purity of calcium sulfate (dihydrate) used is usually 95-98% FCC Grade. The amount of calcium sulfate, in moles per liter of concentrated sulfuric acid ranges from about 0.005 to about 0.15, preferably from about 0.007 to about 0.07, and more preferably from about 0.007 to about 0.04. It is application specific.

In the event that CaSO₄ is used for the reaction by adding it to the solution of concentrated H₂SO₄, the amount of CaSO₄, in grams per liter of solution based on final volume, has the following relationship:

| Final AGIIS | Amount of |
|---|---|
| Acid Normality N | CaSO₄ in g/l |
| 1-5 | 5 |
| 6-10 | 4 |
| 11-15 | 3 |
| 16-20 | 2 |
| 21-36 | 1 |

The AGIIS obtained could have an acid normality range of from about 0.05 to about 31; the pH of lower than 0; boiling point of from about 100 to about 106° C.; freezing point of from about −8° C. to about 0° C.

AGIIS obtained from using the reaction of H₂SO₄/Ca(OH)₂/CaSO₄ had the following analyses (average):

AGIIS with Final Acid Normality of About 1.2 N, pH of −0.08

H₃O⁺, 2.22%; Ca, 602 ppm; SO₄, 73560 ppm; K, 1.36 ppb; impurities of 19.68 ppm, and neither Na nor Mg was detected.

AGIIS with Final Acid Normality of About 29 N, pH of about −1.46

H₃O⁺, 30.68%; Ca, 52.9 ppm; SO₄, 1422160 ppm; K, 38.02 ppb; and neither Na nor Mg was detected.

Aqueous solutions of other alkalis or bases, such as Group IA hydroxide solution or slurry and Group IIA hydroxide solution or slurry can be used. Groups IA and IIA refer to the two Groups in the periodical table. The use of Group IIA hydroxide is preferred. Preferably, the salts formed from using Group IIA hydroxides in the reaction are sparingly soluble in water. It is also preferable to use only Group IIA hydroxide as the base without the addition of Group IA hydroxide.

After the reaction, the resultant concentrated acidic solution with a relatively low pH value, typically below pH 1, can then be diluted with de-ionized water to the desired pH value, such as pH of about 1 or about 1.8.

As discussed above, AGIIS has relatively less dehydrating properties (such as charring sucrose) as compared to the saturated solution of CaSO₄ in the same concentration of H₂SO₄. Further, the stability and non-corrosive nature of the AGIIS of the present invention can be illustrated by the fact that a person can put his or her hand into this solution with a pH of less than 0.5 and, yet, his or her hand suffers no irritation, and no injury. If, on the other hand, one places his or her hand into a solution of sulfuric acid of pH of less than 0.5, an irritation would occur within a relatively short span of time. A solution of 27 N of sulfuric acid saturated with calcium sulfate will cause chemical burn to a human skin after a few seconds of contact. In contrast, AGIIS solution of the same normality would not cause chemical burn to a human skin even after in contact for 5 minutes. The AGIIS does not seem to be corrosive when being brought in contact with the environmental protective covering of plants (cuticle) and animals (skin). AGIIS has low volatility at room temperature and pressure. Even as concentrated as 27 N, the AGIIS has no odor, does not give off fumes in the air, and is not irritating to a human nose when one smells this concentrated solution.

AGIIS, its components, and its methods of preparation are fully described in U.S. Pat. No. 6,436,891, filed Feb. 9, 2000, entitled “Adduct Having an Acidic Solution of Sparingly Soluble Group IIA Complexes;” U.S. Pat. No. 6,572,908, filed Jan. 19, 2001, entitled “Highly Acidic Metalated Organic Acid as a Food Additive;” U.S. patent application Ser. No. 09/500,473, filed Feb. 9, 2000, entitled “Acidic Solution of Sparingly-Soluble Group IIA Complexes;” and U.S. patent application Ser. No. 09/655,131, filed Sep. 5, 2000, entitled “Highly Acidic Metalated Organic Acid,” the entire contents of which are hereby incorporated by reference.

In another preferred embodiment, the acidic adjuvant may comprise a composition of a highly acidic metalated organic acid (“HAMO”). The composition may have a suspension of very fine particles, and it has a monovalent or a polyvalent cation, an organic acid, and an anion of a regenerating acid, such as the anion of a strong oxyacid. The term “highly acidic” means the pH is in the acidic region, below at least about 4, preferably 2.5. HAMO of the present invention is less corrosive to a ferrous metal than a solution of a mineral acid having the same acidic pH value as that of the acidic composition. HAMO is also more biocidal than a mixture of the organic acid and a metal salt of the organic acid which mixture having the same acid normality value as that of the acidic composition.

Broadly, one way HAMO can be prepared is by mixing the following ingredients: (1) at least one regenerating acid; (2) at least one metal base; and (3) at least one organic acid, wherein the equivalent amount of the regenerating acid is in excess of the equivalent amount of the metal base. The equivalent amount of the metal base should be about equal to that of the organic acid. Instead of using a metal base and an organic acid, a metal salt of the organic acid can be used in place of the metal base and the organic acid. The insoluble solid is removed by any conventional method, such as sedimentation, filtration, or centrifugation.

Generally, HAMO can be prepared by blending or mixing the necessary ingredients in at least the following manners:

1. Regenerating acid+(metal base+organic acid);

2. Regenerating acid+(metal base+salt of organic acid);

3. (Regenerating acid+salt of organic acid)+base; and

4. Regenerating acid+salt of organic acid.

The parenthesis in the above scheme denotes “pre-mixing” the two ingredients recited in the parenthesis. Normally, the regenerating acid is added last to generate the HAMO. Although each of the reagents is listed as a single reagent, optionally, more than one single reagent, such as more than one regenerating acid or organic acid, can be used in the current invention. The number of equivalents of the regenerating acid must be larger than the number of equivalents of the metal base, or those of the metal salt of the organic acid. When the organic acid is an amino acid, which, by definition contains at least one amino group, then the number of equivalents of the regenerating acid must be larger than the total number of equivalents of the metal base, or metal salt of the organic acid, and the “base” amino group of the amino acid. Thus, the resultant highly acidic metalated organic acid is different from, and not, a buffer. See, “Highly Acidic Metalated Inorganic Acid,” U.S. application Ser. No. 09/655,131, filed Sep. 5, 2000, the entire content of which is hereby incorporated by reference.

As used herein, a regenerating acid is an acid that will “re-generate” the organic acid from its salt. Examples of a regenerating acid include a strong binary acid, a strong oxyacid, and others. A binary acid is an acid in which protons are directly bound to a central atom, that is (central atom)-H. Examples of a binary acid include HF, HCl, HBr, HI, H₂S and HN₃. An oxyacid is an acid in which the acidic protons are bound to oxygen, which in turn is bound to a central atom, that is (central atom)-O-H. Examples of oxyacid include acids having Cl, Br, Cr, As, Ge, Te, P, B, As, I, S, Se, Sn, Te, N, Mo, W, or Mn as the central atom. Some examples include H₂SO₄, HNO₃, H₂SeO₄, HClO₄, H₃PO₄, and HMnO₄. Some of the acids (e.g. HMnO₄) cannot actually be isolated as such, but occur only in the form of their dilute solutions, anions, and salts. A “strong oxyacid” is an oxyacid, which at a concentration of 1 molar in water gives a concentration of H₃O⁺ greater than about 0.8 molar.

The regenerating acid can also be an acidic solution of sparingly-soluble Group IIA complexes (“AGIIS”).

To create the blend of organic acids and HAMO, the general formulation described above should be followed. The organic acids may be added at any time during the formulation process. HAMO can be formed in the presence of an organic acid, using, for example, propionic acid, calcium lactate, and AGIIS. Alternatively, the organic acids can be added to the final product or premixed with the regenerating acid and then added to the metal salt or base. If a salt is to be added as an additive, including inorganic or organic metal salts or base material, it can be added at any time during the process. However, extra mixing and filtration could be required. If surfactants are to be used, it is preferred that they are added to the final filtered product and mixed until dissolved. Alcohols, if required, should be added to the product after filtration. If a surfactant and an alcohol are used, the alcohol can be added during the mixing of the surfactant to control the foam produced. Peroxides should be mixed in after the product is filtered, but it is highly preferred that they are mixed into the final product immediately prior to use.

HAMO, its components, and its methods of preparation are fully described in U.S. patent application Ser. No. 09/655,131, filed Sep. 5, 2000, entitled “Highly Acidic Metalated Inorganic Acid,” and U.S. Pat. No. 6,572,908, filed Jan. 19, 2001, entitled “Highly Acidic Metalated Organic Acid as a Food Additive,” the entire contents of which are hereby incorporated by reference.

In a further preferred embodiment, the acidic adjuvant may comprise a highly acidic metalated mixture of inorganic acids (“HAMMIA”). The acidulant HAMMIA has an acidic pH, and can be isolated from a mixture prepared by mixing ingredients comprising a salt of phosphoric acid, and a preformed, or in-situ generated, solution or suspension of AGIIS, wherein the solution or suspension of AGIIS is in an amount sufficient to render the acidic pH of the composition to be less than about 2. Another embodiment of HAMMIA involves a composition having an acidic pH, which is isolated from a mixture prepared by mixing ingredients comprising a salt of phosphoric acid, and a preformed, or in-situ generated, solution or suspension of AGIIS, wherein the solution or suspension of AGIIS is in an amount in excess of the amount required to completely convert the salt of phosphoric acid to phosphoric acid.

To create a blend of organic acids with HAMMIA, in accordance with another embodiment of the current invention, the organic acids may be added at any time during the formation of HAMMIA. The HAMMIA regeneration can take place in the presence of the organic acid or acids. If a salt is to be added as an additive, including inorganic or organic metal salts or base material, it can be added at any time during the process. However, extra mixing and filtration could be required. If surfactants are to be used and the product requires filtration, it is preferred that they are added to the final filtered product and mixed until dissolved. If no filtration is required, the addition of the surfactant should be incorporated into the last step of the process. Alcohols, if required, should be added to the product after filtration. If a surfactant and an alcohol are used, the alcohol can be added during the mixing of the surfactant to control the foam produced. Peroxides should be mixed in after the product is filtered, but it is highly preferred that they are mixed into the final product immediately prior to use.

HAMMIA, its components, and its methods of preparation are fully described in U.S. patent application Ser. No. 09/873,755, filed Jun. 4, 2001, entitled “Highly Acidic Metalated Mixture of Organic Acids,” the entire contents of which is hereby incorporated by reference.

In a preferred embodiment, the acidic adjuvant may be present in the food additive composition in a concentration ranging from, based on a 5N solution, about 0.01% to about 5%, more preferably from about 0.6% to about 2%, and most preferably from about 0.55% to about 0.56%. In a preferred embodiment, the acidic adjuvant may be diluted with water to give the desired final concentrations.

The acidic adjuvant may optionally contain one or more additives. The additive of the present invention appears to enhance, and also appears to be synergistic to, the effectiveness of the acidic adjuvant. Examples of the additive include organic acids, amino acids, alcohols, and surfactants. The amount of additive added to the acidic adjuvant varies depending on the desired final weight percent of the additive in the final adduct composition. Preferred concentrations of the additives, which may be used in any combination, within the treated food product, may be anywhere from about 0.01% to about 5%. A more preferred concentration of the additive, alone or in combination, is from about 0.5% to about 2%. The most preferred concentration is from about 0.13% to about 0.14%.

A first preferred additive may comprise one or more organic acids. Any of a number of organic acids may be used. The most preferred organic acids are small carboxylic acids such as lactic acid, propionic acid, and acetic acid. Other organic acids which may be used include maleic acid and tartaric acid.

An additional preferred additive comprises one or more amino acids. Preferred examples of amino acids include any amino acid having a free carboxyl group, and in particular glycine and serine.

The alcohol additive preferred for the present invention includes methanol, ethanol, propanol, i-propanol, and other lower alkyl alcohols.

A surfactant for the present invention is a surface-active agent. It is usually an organic compound consisting of two parts: One, a hydrophobic portion, usually including a long hydrocarbon chain; and two, a hydrophilic portion which renders the compound sufficiently soluble or dispersible in water or another polar solvent. Surfactants are usually classified into: (1) an-ionic, where the hydrophilic moiety of the molecule carries a negative charge; (2) cat-ionic, where this moiety of the molecule carries a positive charge; and (3) non-ionic, which do not dissociate, but commonly derive their hydrophilic moiety from polyhydroxy or polyethoxy structures. Other surfactants include ampholytic and zwitterionic surfactants. A preferred surfactant for the present invention includes polysorbates (Tween 80).

One method of preparing a preferred example of an acidic adjuvant with one or more additives, and in particular a concentrate of the AGIIS having an ethanol additive and a lactic acid additive, is by mixing with stirring at ambient temperature 634 mL of 200 proof FCC ethanol (16.5 weight %); 75 mL. of 85% lactic acid (1.9 weight %); 1536 mL of a solution of AGIIS having a pH of about 0.2-0.4 (40 weight %); and 1595 nL of de-ionized water (41.5 weight %). The resultant concentrate of AGIIS with two additives shows a pH of about 1.65-1.8. One method of preparing a concentrate of the AGIIS having ethanol, lactic, and surfactant (Tween 80) additives is by mixing with stirring at ambient temperature 634 mL of 200 proof FCC ethanol (16.5 weight %); 75 mL. of 85% lactic acid (1.9 weight %); 1920 mL of a solution of AGIIS having a pH of about 0.2-0.4 (50 weight %); 255 mL of Tween 80 (6.6 weight %); and 957.6 mL of de-ionized water (25 weight %). The resultant concentrate of AGIIS with three additives shows a pH of about 1.45-1.7.

The composition of the present invention was found to be a “preservative.” The composition is less corrosive; however, it can create an environment where destructive micro-organisms cannot live and propagate, thus prolonging the shelf-life of the product. The utility of this method of preservation is that additional chemicals do not have to be added to the food or other substance to be preserved because the inherent low pH of the mixture is preservative. Since preservative chemicals do not have to be added to the food substance, taste is improved and residues are avoided. Organoleptic testing of a number of freshly preserved and previously preserved food stuffs have revealed the addition of composition improves taste and eliminates preservative flavors. The term “organoleptic” means making an impression based upon senses of an organ or the whole organism. Use of the composition both as a preservative and taste enhancer for food will produce a safer and more desirable product with extended shelf life. It can also be used as an ingredient to adjust product pH

The blended acidic solution effectively eliminates the presence of pathogenic microorganisms in a food product. “Pathogenic microorganisms” are defined as biological organisms which contaminate the environment, or produce harmful contaminating substances, thus making the environment hazardous. Pathogenic microorganisms may include microbes, molds, and other infectious matter. Microbes are minute organisms including spirochetes, bacteria, rickettsiae, and viruses. Pathogenic microorganisms associated with meat products may include E. coli, L. monocytogenes, Staphylococcus, Campylobacter jejuni, Salmonella, Clostridium perfringes, Toxoplasma gondii, and Botulism. The solution has been shown to be highly effective at inhibiting the growth of pathogenic microorganisms and particularly E. coli and L. monocytogenes.

General examples of a food product include beverages, food additives, beverage additives, food supplements, beverage supplements, seasonings, spices, flavoring agents, stuffings, sauces, doughs, food dressings, raw and cooked meats, dairy products, pharmaceuticals, biological products, and others. The food product can be of plant origin, animal origin, or synthetic. If the food product is of animal origin, it may be an animal prior to slaughter, an animal carcass prior to division, a divided and processed animal carcass, a dried animal product, a smoked animal product, a cured animal product, or an aged animal product. The food product may also be a RTE food product. The food additive composition is particularly effective at eliminating pathogenic microorganisms, preventing the outgrowth of pathogenic microorganisms, and increasing the shelf life of flour-based food products, ground meat products, and cooked meat products.

Contacting a food product with the food additive composition may be done through one of several different methods. The composition may be sprayed onto the product. Alternatively, the product may be dipped into the composition. The composition may also be heated and fogged onto either the food product or the packaging material or both. Preferably, ground, shredded, or otherwise loose food products can be blended and mixed with the food additive composition. Other methods of application which effectively contact the product with the solution may be used as well.

### EXAMPLE 1

### AGIIS Having an Acid Normality of 1.2 to 1.5 Prepared by the Method of H₂SO₄/CA(OH)₂

An amount of 1055 ml (19.2 moles, after purity adjustment and taking into account the amount of acid neutralized by base) of concentrated sulfuric acid (FCC Grade, 95-98% purity) was slowly added with stirring, to 16.868 L of RO/DI water in each of reaction flasks a, b, c, e, and f. The amount of water had been adjusted to allow for the volume of acid and the calcium hydroxide slurry. The mixture in each flask was mixed thoroughly. Each of the reaction flasks was chilled in an ice bath and the temperature of the mixture in the reaction flask was about 8-12° C. The mixture was continuously stirred at a rate of about 700 rpm.

Separately, a slurry was made by adding RO/DI water to 4 kg of calcium hydroxide (FCC Grace, 98% purity) making a final volume of 8 L. The mole ratio of calcium hydroxide to concentrated sulfuric acid was determined to be 0.45 to 1. The slurry was a 50% (w/v) mixture of calcium hydroxide in water. The slurry was mixed well with a high-shear-force mixer until the slurry appeared uniform. The slurry was then chilled to about 8-12° C. in an ice bath and continuous stirred at about 700 rpm.

To each of the reaction flasks was added 150 ml of the calcium hydroxide slurry every 20 minutes until 1.276 L (i.e. 638 g dry weight, 8.61 moles, of calcium hydroxide) of the slurry had been added to each reaction vessel. The addition was again accompanied by efficient mixing at about 700 rpm.

After the completion of the addition of the calcium hydroxide to the reaction mixture in each reaction vessel, the mixture was filtered through a 5-micron filter.

The filtrate was allowed to sit for 12 hours, the clear solution was decanted to discard any precipitate formed. The resulting product was AGIIS having an acid normality of 1.2-1.5.

### EXAMPLE 2

### AGIIS Having an Acid Normality of 2 Prepared by the Method of H₂SO₄/CA(OH)₂/CASO₄

For the preparation of 1 L of 2 N AGIIS, an amount of 79.5 ml (1.44 moles, after purity adjustment and taking into account the amount of acid to be neutralized by base) of concentrated sulfuric acid (FCC Grade, 95-98% purity) was slowly added, with stirring, to 854 ml of RO/DI water in a 2 L reaction flask. Five grams of calcium sulfate (FCC Grade, 95% purity) was then added slowly and with stirring to the reaction flask. The mixture was mixed thoroughly. At this point, analysis of the mixture would usually indicate an acid normality of 2.88. The reaction flask was chilled in an ice bath and the temperature of the mixture in the reaction flask was about 8-12° C. The mixture was continuously stirred at a rate of about 700 rpm.

Separately, a slurry was made by adding 50 ml of RO/DI water to 33.26 g (0.44 mole, after purity adjustment) of calcium hydroxide (FCC Grace, 98% purity) making a final volume of 66.53 ml. The mole ratio of calcium hydroxide to concentrated sulfuric acid was determined to be 0.44 to 1. The slurry was mixed well with a high-shear-force mixer until the slurry appeared uniform. The slurry was then chilled to about 8-12° C. in an ice bath and continuous stirred at about 700 rpm.

The slurry was then slowly added over a period of 2-3 hours to the mixture, still chilled in an ice bath and being stirred at about 700 rpm.

After the completion of the addition of slurry to the mixture, the product was filtered through a 5-micron filter. It was normal to observe a 20% loss in volume of the mixture due to the retention of the solution by the salt and removal of the salt.

The filtrate was allowed to sit for 12 hours, and the clear solution was then decanted to discard any precipitate formed. The resulting product was AGIIS having an acid normality of 2.

### EXAMPLE 3

### AGIIS Having an Acid Normality of 12 Prepared by the Method of H₂SO₄/CA(OH)₂/CASO₄

For the preparation of 1 L of 12 N AGIIS, an amount of 434 ml (7.86 moles, after purity adjustment and taking into account amount of acid neutralized by base) of concentrated sulfuric acid (FCC Grade, 95-98% purity) was slowly added, with stirring, to 284.60 ml of RO/DI water in a 2 L reaction flask. Three grams of calcium sulfate (FCC Grade, 95 % purity) was then added slowly and with stirring to the reaction flask. The mixture was mixed thoroughly. The reaction flask was chilled in an ice bath and the temperature of the mixture in the reaction flask was about 8-12° C. The mixture was continuously stirred at a rate of about 700 rpm.

Separately, a slurry was made by adding 211 ml of RO/DI water to 140.61 g (1.86 moles, after purity adjustment) of calcium hydroxide (FCC Grace, 98% purity) making a final volume of 281.23 ml. The mole ratio of calcium hydroxide to concentrated sulfuric acid was determined to be 0.31. The slurry was mixed well with a high-shear-force mixer until the slurry appeared uniform. The slurry was thenchilledtoabout8-12° C. in an ice bath and continuous stirred at about 700 rpm.

The slurry was then slowly added over a period of 2-3 hours to the acid mixture, still chilled in an ice bath and being stirred at about 700 rpm.

After the completion of the addition of slurry to the mixture, the product was filtered through a 5-micron filter. It was normal to observe a 20% loss in volume of the mixture due to the retention of the solution by the salt and removal of the salt.

### EXAMPLE 4

### Formation of HAMO From Glycolic Acid

1 kg of glycolic acid was dissolved into 1.5 L water. 482 g of calcium hydroxide was slowly added to the solution at which time the entire slurry solidified. 2.75 L of 4.8 N AGIIS was added in 50-ml intervals. The final volume was 5.0 L. The final pH was 1.0-1.5.

### EXAMPLE 5

### General Method for the Formation of an Amino Acid HAMO Using 1.2M Sulfuric Acid as Regenerating Acid

A solution of dilute sulfuric acid approximately 1.2 M in water was prepared by weighing 111.64 g of concentrated (96-98%) sulfuric acid and diluting with water to 1000 mL.

The amino acid or its hydrochloride salt (0.025-0.1 mole) was weighed into an Erlenmeyer flask and approximately 10 mole equivalents of water was added. Solid calcium hydroxide (7.40 g, 0.10 mol) was added to the flask and the mixture was stirred at room temperature for 30 minutes to ensure complete reaction. The dilute sulfuric acid (84.0 mL, 0.10 moles H₂SO₄) was then added to the mixture. The mixture was filtered through a medium-porosity glass frit to give the HAMO. The total acid content of the HAMO was determined by titration against standard tris-(hydroxymethyl)aminomethane (“THAM”).

HAMOs Prepared from Amino Acids by this Method

HAMOs Prepared From Amino Acids by This Method

| | Moles of | |
|---|---|---|
| Amino Acid | Amino Acid | [H₃O+] in HAMO* |
| L-glutamine | 0.10 | 0.133 M¹ |
| L-phenylalanine | 0.05 | 0.185 M² |
| L-asparagine | 0.10 | 0.070 M³ |
| L-histidine.HCl | 0.10 | 0.57 M |
| L-glutamic acid | 0.10 | 0.124 M⁴ |
| L-aspartic acid | 0.10 | 0.170 M⁵ |
| L-lysine.HCl | 0.10 | 0.56 M⁶ |
| L-leucine | 0.10 | 0.173 M⁷ |
| L-alanine | 0.10 | 0.099 M⁸ |
| L-isoleucine | 0.02 | 0.351 M⁹ |
| L-serine | 0.025 | 0.274 M |

*Molarity
¹Ca, 844 ppm; SO₄, 3,120 ppm
²Ca, 390 ppm; SO₄, 13,900 ppm.
³Ca, 625 ppm; SO₄, 3,120 ppm.
⁴Ca, 646 ppm; SO₄, 5,120 ppm.
⁵Ca, 1,290 ppm; SO₄, 3,850 ppm.
⁶Ca, 1,910 ppm; SO₄, 7,560 ppm.
⁷Ca, 329 ppm; SO₄, 315,000 ppm.
⁸Ca, 1,230 ppm; SO₄, 4,480 ppm.
⁹Ca, 749 ppm; SO₄, 314,000 ppm.

HAMOs Prepared with Amino Acids and Metal Bases*

HAMOs Prepared With Amino Acids and Metal Bases*

| Amino Acid | Metal Base | Regenerating Acid |
|---|---|---|
| L-glutamine | Ca(OH)2 | H₂SO₄ |
| L-phenylalanine | Ca(OH)₂ | H₂SO₄ |
| L-asparagine | Ca(OH)₂ | H₂SO₄ |
| L-histidine.HCl | Ca(OH)₂ | H₂SO₄ |
| L-glutamic acid | Ca(OH)₂ | H₂SO₄ |
| L-aspartic acid | Ca(OH)₂ | H₂SO₄ |
| L-lysine.HCl | Ca(OH)₂ | H₂SO₄ |
| L-leucine | Ca(OH)₂ | H₂SO₄ |
| L-alanine | Ca(OH)₂ | H₂SO₄ |
| L-isoleucine | Ca(OH)₂ | H₂SO₄ |
| L-serine | Ca(OH)₂ | H₂SO₄ |
| glycine | Ca(OH)₂ | H₂SO₄ |
| L-glutamic acid | CuCO₃.Cu(OH)₂ | H₃PO₄ |
| L-glutamic acid | 2CoCO₃.3Co(OH)₂ | H₃PO₄ |
| L-glutamic acid | MnCO₃ | H₃PO₄ |

*Each of the product has a pH of lower than about 3.

### EXAMPLE 6

### Formation of a Phosphoric Acid HAMMIA Using Pre-Formed AGIIS

The phosphate salt of a divalent metal chosen from List A below (1.00 mole equivalents) is suspended in sufficient deionized water to make a final volume of 625 mL per mole of phosphate ions. The mixture may be sonicated or heated as necessary to aid solubilization of the sparingly soluble phosphate salt. To this stirred suspension, a solution of AGIIS containing the desired concentration of acid (3.05 moles of hydrogen ion per mole of phosphate ion; 2.05 moles of hydrogen ion per mole of hydrogen phosphate ion; 1.05 moles of hydrogen ion per mole of dihydrogen phosphate ion) is added in 10-mL aliquots with the pH being monitored after each addition. Copious precipitates of calcium sulfate form beginning at pH 2. The addition of AGIIS solution may be discontinued as soon as the desired pH is reached. After the addition of the acid is complete, the mixture is stirred for one hour. The agitation is then stopped and the mixture is allowed to settle overnight (approximately 18 hours). The suspended solids are removed by centrifugation at 16000 rpm for 30 minutes. The supernatant solution is the HAMMIA.

List A: Phosphate Salts

Mg₃(PO₄)₂, MgHPO₄, Mg(H₂PO₄)₂

Ca₃(PO₄)₂, CaHPO₄, Ca(H₂PO₄)₂

Mn₃(PO₄)₂, MnHPO₄, Mn(H₂PO₄)₂

Fe₃(PO₄)₂, FeHPO₄, Fe(H₂PO₄)₂

Co₃(PO₄)₂, CoHPO₄, Co(H₂PO₄)₂

Ni₃(PO₄)₂, NiHPO₄, Ni(H₂PO₄)₂

Cu₃(PO₄)₂, CuHPO₄, Cu(H₂PO₄)₂

Zn₃(PO₄)₂, ZnHPO₄, Zn(H₂PO₄)₂

### EXAMPLE 7

### Formation of a Phosphoric Acid HAMMIA Using AGIIS Formed In Situ

A mixture of calcium hydroxide (1.00 mole equivalents) and the phosphate salt of a divalent metal chosen from List A below (1.00 mole equivalents) is suspended in sufficient deionized water to make a final volume of approximately 400 mL per mole of metal ions. The mixture may be sonicated or heated as necessary to aid solubilization of the sparingly soluble metal salts. To this stirred suspension, concentrated sulfuric acid (5.05 mole equivalents of hydrogen ion per mole of phosphate ion) is added in 10-mL aliquots with the pH being monitored after each addition. The addition of acid may be discontinued when the desired pH is reached. After the addition of the acid is complete, the mixture is stirred for one hour. The agitation is then stopped and the mixture is allowed to settle overnight (approximately 18 hours). The suspended solids are removed by centrifugation at 16000 rpm for 30 minutes. The supernatant solution is the HAMMIA.

List A: Phosphate Salts

Mg₃(PO₄)₂, MgHPO₄, Mg(H₂PO₄)₂

Ca₃(PO₄)₂, CaHPO₄, Ca(H₂PO₄)₂

Mn₃(PO₄)₂, MnHPO₄, Mn(H₂PO₄)₂

Fe₃(PO₄)₂, FeHPO₄, Fe(H₂PO₄)₂

Co₃(PO₄)₂, CoHPO₄, Co(H₂PO₄)₂

Ni₃(PO₄)₂, NiHPO₄, Ni(H₂PO₄)₂

Cu₃(PO₄)₂, CuHPO₄, Cu(H₂PO₄)₂

Zn₃(PO₄)₂, ZnHPO₄, Zn(H₂PO₄)₂

### EXAMPLE 8

### Formation of a Phosphoric Acid HAMMIA Containing a Monovalent Metal Using Pre-Formed AGIIS

The phosphate salt of a divalent metal chosen from List A below (1.00 mole equivalents) and the phosphate salt of a monovalent metal chosen from List B below (≦1.00 mole equivalents) is suspended in sufficient deionized water to make a final volume of 625 mL per mole of phosphate ions. The mixture may be sonicated or heated as necessary to aid solubilization of the sparingly soluble divalent metal phosphate salt. To this stirred suspension, a solution of AGIIS containing the desired concentration of acid (3.05 moles of hydrogen ion per mole of phosphate ion; 2.05 moles of hydrogen ion per mole of hydrogen phosphate ion; 1.05 moles of hydrogen ion per mole of dihydrogen phosphate ion) is added in 10-mL aliquots with the pH being monitored after each addition. Copious precipitates of calcium sulfate form beginning at pH 2. The addition of AGIIS solution may be discontinued as soon as the desired pH is reached. After the addition of the acid is complete, the mixture is stirred for one hour. The agitation is then stopped and the mixture is allowed to settle overnight (approximately 18 hours). The suspended solids are removed by centrifugation at 16000 rpm for 30 minutes. The supernatant solution is the HAMMIA.

| List A: | List B: |
|---|---|
| Divalent Metal Phosphate Salts | Monovalent Metal Phosphate Salts |
| Mg₃(PO₄)₂, MgHPO₄, Mg(H₂PO₄)₂ | Li₃PO₄, Li₂HPO₄, LiH₂PO₄ |
| Ca₃(PO₄)₂, CaHPO₄, Ca(H₂PO₄)₂ | Na₃PO₄, Na₂HPO₄, NaH₂PO₄ |
| Mn₃(PO₄)₂, MnHPO₄, Mn(H₂PO₄)₂ | K₃PO₄, K₂HPO₄, KH₂PO₄ |
| Fe₃(PO₄)₂, FeHPO₄, Fe(H₂PO₄)₂ | |
| Co₃(PO₄)₂, CoHPO₄, Co(H₂PO₄)₂ | |
| Ni₃(PO₄)₂, NiHPO₄, Ni(H₂PO₄)₂ | |
| Cu₃(PO₄)₂, CuHPO₄, Cu(H₂PO₄)₂ | |
| Zn₃(PO₄)₂, ZnHPO₄, Zn(H₂PO₄)₂ | |

### EXAMPLE 9

### Preparation of an Example Acidic Adjuvant

To prepare one example of an acidic adjuvant which can be used in the current food additive composition, 240 g of water was first measured into a container. The contents of the container were subjected to constant mixing during the entire process. Next, 321.3 g of propionic acid, 396.3 g of lactic acid, 93.7 g of 5N AGIIS, and 24.1 g of disodium phosphate were added to the container. Mixing continued until the disodium phosphate was completely dissolved.

Prior to use, the concentrate was diluted 1:2, or one part solution to two parts water. The final pH of the solution was 1.5.

### EXAMPLE 10

### Preparation of an Additional Example Acidic Adjuvant

To prepare a second example of an acidic adjuvant which can be used in the current food additive composition, 536.7 g of water was first measured into a container. The contents of the container were subjected to constant mixing during the entire process. Next, 405.7 g of lactic acid, 109.4 g of 5N AGIIS, and 23.8 g of disodium phosphate were added to the container. Mixing continued until the disodium phosphate was completely dissolved.

Prior to use, the concentrate was diluted 1:3, or one part solution to three parts water. The final pH of the solution was 1.5.

### EXAMPLE 11

### Effects of Food Additive Composition Treatment on L. monocytogenes in Ground Meat

Six groups of 20 g ground uncooked turkey balls were prepared, with 27 balls prepared per group. Group A was untreated and served as a control. Groups B-F were blended with varying amounts of ε-polylysine (“ε-PL”). Final concentrations of ε-polylysine within the turkey balls were:

| Group | ε-Polylysine Concentration |
|---|---|
| B | 1000 ppm |
| C | 2000 ppm |
| D | 3000 ppm |
| E | 4000 ppm |
| F | 5000 ppm |

After preparation, all meatballs were placed on baking sheets and baked in a conventional oven at 350° F. for 20 minutes. After baking, the meatballs were packaged separately and stored at 4° C.

Five strains of Listeria monocytogenes were cultured separately overnight at 37° C. in BHI broth and mixed in equal proportions just before use. The mixture was further diluted 1:10,000 times with sterile saline to produce a suspension for use. The meat inoculation level was determined by removing an aliquot of the mixture, making a serial dilution and plating serial dilutions onto agar plates (Modified Oxford Listeria Selective Agar plates).

The prepared meat balls were carefully unpacked and removed from the original packages onto a sterile surface inside a laminar flow bio-safety hood. 20 microliters of the Listeria monocytogenes suspension was inoculated onto the exterior of each turkey ball. Turkey balls were incubated at room temperature for 30 min post-inoculation to allow bacteria to attach. Turkey balls were individually vacuum packaged and stored at 10° C.

The microbiological assay was performed after 3 hours, 24 hours, 1 week, 2 weeks, 3 weeks, 4 weeks, 5 weeks, 7 weeks, and 8 weeks. After each designated time period had passed, three bags from each group of meat balls were unpacked, transferred to a stomacher bag along with 20 ml of sterile 0.1% peptone water. Each meatball was hand crushed and stomached at high speed for 2 minutes. Colony forming units (“CFU”) per gram of meat was determined by serial dilution of an aliquot from each stomached meatball and plating on Agar plates. After plating, all plates were incubated at 37° C. for about 48 hours before CFU determination. Log reductions were calculated with regard to control Group A. The results are shown in Tables 1.1-1.9 below. The letter “\overline{A}” denotes average.

TABLE 1.1
After 3 hours

| | ε-PL | | | | Log |
|---|---|---|---|---|---|
| Group | (ppm) | CFU/g | \overline{A} of CFU/g¹ | \overline{A} Log Value | Reduction |
| A | 0 | 5.52E+02 | 6.12E+02 | 2.79 | — |
| | | 5.18E+02 | | | |
| | | 7.66E+02 | | | |
| B | 1000 | 1.56E+02 | 1.81E+02 | 2.26 | 0.53 |
| | | 2.34E+02 | | | |
| | | 1.54E+02 | | | |
| C | 2000 | 1.94E+02 | 1.80E+02 | 2.26 | 0.53 |
| | | 1.96E+02 | | | |
| | | 1.50E+02 | | | |
| D | 3000 | 2.00E+01 | 3.20E+01 | 1.51 | 1.28 |
| | | 2.80E+01 | | | |
| | | 4.80E+01 | | | |
| E | 4000 | 2.60E+01 | <1.47E+01 | <1.17 | >1.62 |
| | | 1.60E+01 | | | |
| | | <2.00E+00 | | | |
| F | 5000 | 6.00E+00 | 4.00E+00 | 0.60 | 2.18 |
| | | 4.00E+00 | | | |
| | | 2.00E+00 | | | |

¹Detection limit of 2 CFU/g.

TABLE 1.2
After 24 hours

| | ε-PL | | | | Log |
|---|---|---|---|---|---|
| Group | (ppm) | CFU/g | \overline{A} of CFU/g¹ | \overline{A} Log Value | Reduction |
| A | 0 | >4.00E+03 | >5.33E+03 | >3.73 | — |
| | | >8.00E+03 | | | |
| | | >4.00E+03 | | | |
| B | 1000 | 2.80E+03 | 1.77E+03 | 3.25 | >0.48 |
| | | 1.05E+03 | | | |
| | | 1.46E+03 | | | |
| C | 2000 | 1.98E+02 | 2.25E+02 | 2.35 | >1.37 |
| | | 2.64E+02 | | | |
| | | 2.14E+02 | | | |
| D | 3000 | 5.00E+01 | 6.20E+01 | 1.79 | >1.93 |
| | | 6.40E+01 | | | |
| | | 7.20E+01 | | | |
| E | 4000 | 1.40E+01 | 1.93E+01 | 1.29 | >2.44 |
| | | 8.00E+00 | | | |
| | | 3.60E+01 | | | |
| F | 5000 | 8.00E+00 | 5.33E+00 | 0.73 | >3.00 |
| | | 6.00E+00 | | | |
| | | 2.00E+00 | | | |

¹Detection limit of 2 CFU/g.

TABLE 1.3
After 1 week

| | ε-PL | | | | Log |
|---|---|---|---|---|---|
| Group | (ppm) | CFU/g | \overline{A} of CFU/g¹ | \overline{A} Log Value | Reduction |
| A | 0 | 2.00E+08 | 1.91E+08 | 8.28 | — |
| | | 2.19E+08 | | | |
| | | 1.53E+08 | | | |
| B | 1000 | 4.05E+06 | 4.38E+06 | 6.64 | 1.64 |
| | | 5.35E+06 | | | |
| | | 3.75E+06 | | | |
| C | 2000 | 1.32E+05 | 5.50E+04 | 4.74 | 3.54 |
| | | 9.30E+02 | | | |
| | | 3.21E+04 | | | |
| D | 3000 | 1.80E+01 | 1.00E+01 | 1.00 | 7.28 |
| | | 8.00E+00 | | | |
| | | 4.00E+00 | | | |
| E | 4000 | <2.00E+00 | <3.35E+00 | <0.52 | >7.76 |
| | | <2.00E+00 | | | |
| | | 6.00E+00 | | | |
| F | 5000 | 4.00E+00 | 8.87E+01 | 1.95 | 6.33 |
| | | 2.00E+00 | | | |
| | | 2.60E+02 | | | |

¹Detection limit of 2 CFU/g.

TABLE 1.4
After 2 weeks

| | ε-PL | | | | Log |
|---|---|---|---|---|---|
| Group | (ppm) | CFU/g | \overline{A} of CFU/g¹ | \overline{A} Log Value | Reduction |
| A | 0 | 5.84E+07 | 1.95E+08 | 8.29 | — |
| | | 2.57E+08 | | | |
| | | 2.71E+08 | | | |
| B | 1000 | 3.01E+07 | 4.09E+07 | 7.61 | 0.68 |
| | | 6.42E+07 | | | |
| | | 2.85E+07 | | | |
| C | 2000 | 1.31E+04 | 9.57E+04 | 4.98 | 3.31 |
| | | 9.87E+03 | | | |
| | | 2.64E+05 | | | |
| D | 3000 | 2.00E+00 | 2.73E+01 | 1.44 | 6.85 |
| | | 7.20E+01 | | | |
| | | 8.00E+00 | | | |
| E | 4000 | <2.00E+00 | <2.00E+00 | <0.30 | >7.29 |
| | | <2.00E+00 | | | |
| | | <2.00E+00 | | | |
| F | 5000 | <2.00E+00 | <2.00E+00 | <0.30 | >7.99 |
| | | <2.00E+00 | | | |
| | | <2.00E+02 | | | |

¹Detection limit of 2 CFU/g.

TABLE 1.5
After 3 weeks

| | | ε-PL | | | | Log |
|---|---|---|---|---|---|---|
| Group | | (ppm) | CFU/g | \overline{A} of CFU/g¹ | \overline{A} Log Value | Reduction |
| | A | 0 | 2.21E+08 | 2.47E+08 | 8.39 | — |
| | | | 2.52E+08 | | | |
| | | | 2.69E+08 | | | |
| | B | 1000 | 1.36E+07 | 5.24E+06 | 6.73 | 1.66 |
| | | | 1.33E+05 | | | |
| | | | 2.53E+06 | | | |
| | C | 2000 | 6.17E+04 | 4.73E+04 | 4.68 | 3.72 |
| | | | 2.02E+04 | | | |
| | | | 6.01E+04 | | | |
| | D | 3000 | <2.00E+00 | <4.67E+01 | <1.67 | >6.72 |
| | | | 1.36E+02 | | | |
| | | | <2.00E+00 | | | |
| | E | 4000 | <2.00E+00 | <2.00E+00 | <0.3 | >8.09 |
| | | | <2.00E+00 | | | |
| | | | <2.00E+00 | | | |
| | F | 5000 | <2.00E+00 | <2.00E+00 | <0.30 | >8.09 |
| | | | <2.00E+00 | | | |
| | | | <2.00E+00 | | | |

¹Detection limit of 2 CFU/g.

TABLE 1.6
After 4 weeks

| | ε-PL | | | | Log |
|---|---|---|---|---|---|
| Group | (ppm) | CFU/g | \overline{A} of CFU/g¹ | \overline{A} Log Value | Reduction |
| A | 0 | 3.19E+08 | 2.98E+08 | 8.47 | — |
| | | 2.59E+08 | | | |
| | | 3.16E+08 | | | |
| B | 1000 | 1.23E+08 | 5.42E+07 | 7.73 | 0.74 |
| | | 1.52E+07 | | | |
| | | 2.45E+07 | | | |
| C | 2000 | >4.00E+06 | >2.76E+06 | >6.44 | <2.03 |
| | | 2.73E+05 | | | |
| | | >4.00E+06 | | | |
| D | 3000 | 4.00E+00 | <2.67E+00 | <0.43 | >8.05 |
| | | <2.00E+01 | | | |
| | | <2.00E+00 | | | |
| E | 4000 | 2.00E+00 | <2.00E+00 | <0.30 | >8.17 |
| | | <2.00E+00 | | | |
| | | <2.00E+00 | | | |
| F | 5000 | <2.00E+00 | <2.00E+00 | <0.30 | <8.17 |
| | | <2.00E+00 | | | |
| | | <2.00E+02 | | | |

¹Detection limit of 2 CFU/g.

TABLE 1.7
After 5 weeks

| | ε-PL | | | | Log |
|---|---|---|---|---|---|
| Group | (ppm) | CFU/g | \overline{A} of CFU/g¹ | \overline{A} Log Value | Reduction |
| A | 0 | 2.16E+08 | 2.65E+08 | 8.42 | — |
| | | 2.13E+08 | | | |
| | | 3.67E+08 | | | |
| B | 1000 | 4.15E+07 | 9.64E+07 | 7.98 | 0.44 |
| | | 6.47E+07 | | | |
| | | 1.83E+08 | | | |
| C | 2000 | 1.47E+06 | 7.91E+05 | 5.90 | 2.53 |
| | | 2.13E+05 | | | |
| | | 2.29E+05 | | | |
| D | 3000 | <2.00E+00 | <2.00E+00 | <0.30 | >8.12 |
| | | <2.00E+00 | | | |
| | | <2.00E+00 | | | |
| E | 4000 | <2.00E+00 | <2.00E+00 | <0.30 | >8.12 |
| | | <2.00E+00 | | | |
| | | <2.00E+00 | | | |
| F | 5000 | <2.00E+00 | <2.00E+00 | <0.30 | >8.12 |
| | | <2.00E+00 | | | |
| | | <2.00E+00 | | | |

¹Detection limit of 2 CFU/g.

TABLE 1.8
After 7 weeks

| | ε-PL | | | | Log |
|---|---|---|---|---|---|
| Group | (ppm) | CFU/g | \overline{A} of CFU/g¹ | \overline{A} Log Value | Reduction |
| A | 0 | 2.77E+08 | 2.64E+08 | 8.42 | — |
| | | 2.16E+08 | | | |
| | | 2.99E+08 | | | |
| B | 1000 | 3.60E+07 | 6.33E+07 | 7.80 | 0.62 |
| | | 8.27E+07 | | | |
| | | 7.13E+07 | | | |
| C | 2000 | 1.91E+05 | 4.53E+06 | 6.66 | 1.77 |
| | | 3.12E+05 | | | |
| | | 1.31E+07 | | | |
| D | 3000 | 3.20E+01 | <1.20E+01 | <1.08 | >7.34 |
| | | <2.00E+00 | | | |
| | | <2.00E+00 | | | |
| E | 4000 | <2.00E+00 | <2.00E+00 | <0.30 | >8.12 |
| | | <2.00E+00 | | | |
| | | — | | | |
| F | 5000 | <2.00E+00 | <2.00E+00 | <0.30 | >8.12 |
| | | <2.00E+00 | | | |
| | | <2.00E+00 | | | |

¹Detection limit of 2 CFU/g.

TABLE 1.9
After 8 weeks

| | ε-PL | | | | Log |
|---|---|---|---|---|---|
| Group | (ppm) | CFU/g | \overline{A} of CFU/g¹ | \overline{A} Log Value | Reduction |
| A | 0 | 1.67E+08 | 2.16E+08 | 8.33 | — |
| | | 2.36E+08 | | | |
| | | 2.45E+08 | | | |
| B | 1000 | 4.40E+07 | 4.53E+07 | 7.66 | 0.68 |
| | | 1.20E+07 | | | |
| | | 8.00E+07 | | | |
| C | 2000 | 1.63E+05 | 1.54E+06 | 6.19 | 2.15 |
| | | 2.23E+06 | | | |
| | | 2.23E+06 | | | |
| D | 3000 | <2.00E+00 | <2.00E+00 | <0.30 | >8.03 |
| | | <2.00E+00 | | | |
| | | <2.00E+00 | | | |
| E | 4000 | <2.00E+00 | <2.00E+00 | <0.30 | >8.03 |
| | | <2.00E+00 | | | |
| | | <2.00E+00 | | | |
| F | 5000 | <2.00E+00 | <2.00E+00 | <0.30 | >8.03 |
| | | <2.00E+00 | | | |
| | | <2.00E+00 | | | |

¹Detection limit of 2 CFU/g.

As the results show, the addition of ε-polylysine to ground turkey at a final concentration of 3000 ppm completely inhibited the outgrowth of Listeria over an eight week period when the inoculated meatballs were incubated at 10° C. In addition, as can be seen from the results, ε-polylysine added at a concentration of 3000 ppm caused a post-lethality effect of >1 log. Thus, the food additive composition produces a sustained outgrowth effect.

### EXAMPLE 12

### Effects of Food Additive Composition with Acidic Adjuvant on L. monocytogenes in Ground Meat

Four groups of 20 g ground uncooked turkey balls were prepared, with 54 balls prepared per group. Group A was untreated and served as a control. Groups B-D were blended with varying amounts of ε-polylysine (“ε-PL”). Final concentrations of ε-polylysine within the turkey balls were:

| Group | ε-Polylysine Concentration |
|---|---|
| B | 1000 ppm |
| C | 2000 ppm |
| D | 3000 ppm |

After preparation, all meatballs were placed on baking sheets and baked in a conventional oven at 350° F. for 20 minutes. After baking, the meatballs were packaged separately and stored at 4° C.

Five strains of Listeria monocytogenes were cultured separately for eight days at 8° C. in BHI broth and mixed in equal proportions just before use. The mixture was further diluted 1:5000 times with sterile saline to produce a suspension for use. The prepared meat balls were carefully unpacked and removed from the original packages onto a sterile surface inside a laminar flow bio-safety hood. 20 microliters of the Listeria monocytogenes suspension was inoculated onto the exterior of each turkey ball. The turkey balls were incubated at room temperature for 30 min post-inoculation to allow bacteria to attach.

Each group of meatballs (54 per group) was divided into two groups of 27 meatballs and labeled as control or treated meatballs as follows: A_{C}, A_{T}, B_{C}, B_{T}, C_{C}, C_{T}, D_{C} and D_{T}, respectively. Control meatballs labeled A_{C}, B_{C}, C_{C}, and D_{C} were sprayed for 5 seconds with sterile water. Treated meatballs labeled A_{T}, B_{T}, C_{T} and D_{T} were sprayed for 5 seconds with the acidic adjuvant prepared in Example 4 above (Safe₂O®_{brand}RTE 01, Mionix Corporation, Rocklin, Calif.) diluted 2 parts water to 1 part solution, having a final pH of about 1.5. After the spray treatment, the meatballs were packaged individually, vacuum sealed and incubated at 8° C.

The microbiological assay was performed after 24 hours, 1 week, 2 weeks, 3 weeks, and 4 weeks. After each designated time period had passed, three bags from each group of meat balls were unpacked, transferred to a stomacher bag along with 20 ml of sterile 0.1% peptone water. Each meatball was hand crushed and stomached at high speed for 2 minutes. Colony forming units (“CFU”) per gram of meat was determined by serial dilution of an aliquot from each stomached meatball and plating on Agar plates. After plating, all plates were incubated at 37° C. for about 48 hours before CFU determination. Log reductions were calculated with regard to control Group A. The results are shown in Tables 2.1-2.5 below.

TABLE 2.1
After 24 hours

| | | | | \overline{A} | Log |
|---|---|---|---|---|---|
| Group | Treatment | CFU/g | \overline{A} of CFU/g¹ | Log Value | Reduction |
| A_{C} | None | 7.45E+03 | 5.03E+03 | 3.70 | — |
| | | 6.87E+03 | | | |
| | | 7.72E+02 | | | |
| A_{T} | Acidic spray | 7.80E+01 | 7.13E+01 | 1.85 | 1.85 |
| | | 9.60E+01 | | | |
| | | 4.00E+01 | | | |
| B_{C} | 1000 ppm ε- | 2.49E+02 | 1.67E+02 | 2.22 | 1.48 |
| | PL | 7.40E+01 | | | |
| | | 1.78E+02 | | | |
| B_{T} | 1000 ppm ε- | 6.00E+01 | 8.07E+01 | 1.91 | 1.79 |
| | PL + Acidic | 8.00E+01 | | | |
| | spray | 1.02E+02 | | | |
| C_{C} | 2000 ppm ε- | 1.80E+01 | 2.27E+01 | 1.36 | 2.35 |
| | PL | 1.60E+01 | | | |
| | | 3.40E+01 | | | |
| C_{T} | 2000 ppm ε- | 3.40E+01 | 2.00E+01 | 1.30 | 2.40 |
| | PL + Acidic | 1.60E+01 | | | |
| | spray | 1.00E+01 | | | |
| D_{C} | 3000 ppm ε- | 1.40E+01 | 1.33E+01 | 1.12 | 2.58 |
| | PL | 1.60E+01 | | | |
| | | 1.00E+01 | | | |
| D_{T} | 3000 ppm ε- | 8.60E+01 | 6.20E+01 | 1.79 | 1.91 |
| | PL + Acidic | 8.60E+01 | | | |
| | spray | 1.40E+01 | | | |

¹Detection limit of 2 CFU/g.

TABLE 2.2
After 1 week

| | | | \overline{A} of | \overline{A} Log | Log |
|---|---|---|---|---|---|
| Group | Treatment | CFU/g | CFU/g¹ | Value | Reduction |
| A_{C} | None | 2.04E+08 | 2.35E+08 | 8.37 | — |
| | | 2.47E+08 | | | |
| | | 2.53E+08 | | | |
| A_{T} | Acidic spray | 2.80E+04 | 8.90E+04 | 4.95 | 3.42 |
| | | 1.84E+05 | | | |
| | | 5.51E+04 | | | |
| B_{C} | 1000 ppm ε- | 7.19E+05 | 2.41E+05 | 5.38 | 2.99 |
| | PL | 2.57E+03 | | | |
| | | 1.05E+03 | | | |
| B_{T} | 1000 ppm ε- | 4.48E+03 | 7.63E+03 | 3.88 | 4.49 |
| | PL + Acidic | 1.64E+04 | | | |
| | spray | 2.00E+03 | | | |
| C_{C} | 2000 ppm ε- | 3.00E+01 | 2.53E+01 | 1.40 | 6.97 |
| | PL | 3.20E+01 | | | |
| | | 1.40E+01 | | | |
| C_{T} | 2000 ppm ε- | 1.51E+03 | 7.20E+02 | 2.86 | 5.51 |
| | PL + Acidic | 2.66E+02 | | | |
| | spray | 3.84E+02 | | | |
| D_{C} | 3000 ppm ε- | 1.60E+01 | <8.67E+00 | <0.94 | >7.43 |
| | PL | 8.00E+00 | | | |
| | | <2.00E+00 | | | |
| D_{T} | 3000 ppm ε- | 4.03E+03 | 2.52E+03 | 3.40 | 4.97 |
| | PL + Acidic | 7.33E+02 | | | |
| | spray | 2.79E+03 | | | |

¹Detection limit of 2 CFU/g.

TABLE 2.3
After 2 weeks

| | | | \overline{A} of | \overline{A} Log | Log |
|---|---|---|---|---|---|
| Group | Treatment | CFU/g | CFU/g¹ | Value | Reduction |
| A_{C} | None | 8.04E+08 | 6.96E+08 | 8.84 | — |
| | | 6.25E+08 | | | |
| | | 6.59E+08 | | | |
| A_{T} | Acidic spray | 8.00E+06 | 7.64E+06 | 6.88 | 1.96 |
| | | 9.07E+06 | | | |
| | | 5.84E+06 | | | |
| B_{C} | 1000 ppm ε- | 1.27E+05 | 5.72E+04 | 4.76 | 4.09 |
| | PL | 1.88E+03 | | | |
| | | 4.27E+04 | | | |
| B_{T} | 1000 ppm ε- | 8.83E+04 | 1.45E+05 | 5.16 | 3.68 |
| | PL + Acidic | 6.21E+04 | | | |
| | spray | 2.84E+05 | | | |
| C_{C} | 2000 ppm ε- | 5.59E+04 | 1.88E+04 | 4.27 | 4.57 |
| | PL | 4.64E+02 | | | |
| | | 2.00E+00 | | | |
| C_{T} | 2000 ppm ε- | 5.52E+02 | 1.46E+04 | 4.16 | 4.68 |
| | PL + Acidic | 3.91E+04 | | | |
| | spray | 4.05E+03 | | | |
| D_{C} | 3000 ppm ε- | 4.36E+02 | <1.61E+02 | <2.21 | <6.64 |
| | PL | <2.00E+00 | | | |
| | | 4.40E+01 | | | |
| D_{T} | 3000 ppm ε- | 1.07E+03 | 2.03E+04 | 4.31 | 4.54 |
| | PL + Acidic | 5.13E+04 | | | |
| | spray | 8.47E+03 | | | |

¹Detection limit of 2 CFU/g.

TABLE 2.4
After 3 weeks

| | | | \overline{A} of | \overline{A} Log | Log |
|---|---|---|---|---|---|
| Group | Treatment | CFU/g | CFU/g¹ | Value | Reduction |
| A_{C} | None | 5.93E+07 | 1.92E+08 | 8.25 | — |
| | | 4.89E+07 | | | |
| | | 4.68E+08 | | | |
| A_{T} | Acidic spray | 1.80E+08 | 1.36E+08 | 8.13 | 0.15 |
| | | 8.09E+07 | | | |
| | | 1.47E+08 | | | |
| B_{C} | 1000 ppm ε- | 2.15E+06 | 8.75E+05 | 5.94 | 2.34 |
| | PL | 2.47E+05 | | | |
| | | 2.29+05 | | | |
| B_{T} | 1000 ppm ε- | 5.64E+06 | 4.79E+05 | 6.68 | 1.60 |
| | PL + Acidic | 2.25E+06 | | | |
| | spray | 6.48E+06 | | | |
| C_{C} | 2000 ppm ε- | 6.60E+01 | 8.96E+02 | 2.95 | 5.33 |
| | PL | 2.61E+03 | | | |
| | | 1.30E+01 | | | |
| C_{T} | 2000 ppm ε- | 5.00E+06 | 1.70E+06 | 6.23 | 2.05 |
| | PL + Acidic | 4.02E+04 | | | |
| | spray | 4.61E+04 | | | |
| D_{C} | 3000 ppm ε- | <2.00E+00 | <2.00E+00 | <0.30 | <7.98 |
| | PL | <2.00E+00 | | | |
| | | <2.00E+00 | | | |
| D_{T} | 3000 ppm ε- | 2.40E+02 | 1.07E+04 | 5.03 | 3.25 |
| | PL + Acidic | 5.65E+03 | | | |
| | spray | 3.15E+05 | | | |

¹Detection limit of 2 CFU/g.

TABLE 2.5
After 4 weeks

| | | | \overline{A} of | \overline{A} Log | Log |
|---|---|---|---|---|---|
| Group | Treatment | CFU/g | CFU/g¹ | Value | Reduction |
| A_{C} | None | 2.75E+08 | 3.78E+08 | 8.58 | — |
| | | 3.67E+08 | | | |
| | | 4.92E+08 | | | |
| A_{T} | Acidic spray | 1.44E+08 | 1.68E+08 | 8.23 | 0.35 |
| | | 2.11E+08 | | | |
| | | 1.49E+08 | | | |
| B_{C} | 1000 ppm ε- | 2.37E+06 | 4.64E+06 | 6.67 | 1.91 |
| | PL | 3.81E+06 | | | |
| | | 7.73E+06 | | | |
| B_{T} | 1000 ppm ε- | 1.57E+07 | 1.42E+07 | 7.15 | 1.43 |
| | PL + Acidic | 1.01E+07 | | | |
| | spray | 1.68E+07 | | | |
| C_{C} | 2000 ppm ε- | 1.79E+03 | 7.18E+03 | 3.86 | 4.72 |
| | PL | 1.71E+04 | | | |
| | | 2.64E+03 | | | |
| C_{T} | 2000 ppm ε- | 3.00E+06 | 1.47E+06 | 6.17 | 2.41 |
| | PL + Acidic | 2.56E+05 | | | |
| | spray | 1.15E+06 | | | |
| D_{C} | 3000 ppm ε- | 1.20E+01 | >3.61E+03 | >3.56 | <5.02 |
| | PL | 6.82E+03 | | | |
| | | >4.00E+03 | | | |
| D_{T} | 3000 ppm ε- | 9.87E+05 | >1.14E+06 | >6.06 | <2.52 |
| | PL + Acidic | 4.35E+05 | | | |
| | spray | >2.00E+06 | | | |

¹Detection limit of 2 CFU/g.

As can be seen from Tables 2.1-2.5 above, ε-PL by itself was more effective in controlling the outgrowth of Listeria than the effect of a secondary spray application of the acidic adjuvant for 5 sec. ε-PL is very basic and the ineffectiveness of a secondary spray application is attributed to neutralization of the acidic adjuvant on the surface of the turkey meatballs, particularly at the higher ε-PL concentrations added to the meatballs, i.e., at the 2000 to 3000 ppm levels.

### EXAMPLE 13

### Effects of Food Additive Composition on E. coli in Dough

Four portions of dumpling dough were prepared by blending 200 g of all purpose flour with 113 g of water and varying amounts of ε-polylysine (“ε-PL”), to create four different groups. Group A was untreated and served as a control. Group B was mixed with 524 g of ε-polylysine, Group C was mixed with 1248 g of ε-polylysine, and Group D was mixed with 1872 g of ε-polylysine. Final concentrations of ε-polylysine within Groups B-D were:

| Group | ε-Polylysine Concentration |
|---|---|
| B | 1000 ppm |
| C | 2000 ppm |
| D | 3000 ppm |

Each group of dough formulations was divided into 16 pieces each, and the pieces were rolled flat to make sixteen flat pieces A ground pork and vegetable mixture stuffing was placed in the center of each dough piece and wrapped around the mixture. The uncooked dumplings were placed in boiling water and boiled until all the dumplings floated. The dumplings were removed, and the excess water was briefly drained. The dumplings were packed when still hot and stored at 4° C.

Five strains of E. coli were cultured separately for 18 hours at 37° C. and mixed in equal proportions just before use. The mixture was further diluted to a final concentration of 6×10³ cfu/20 micro liters. The inoculation level was determined after the fact by removing an aliquot of the mixture, making a serial dilution and plating serial dilutions onto E. coli. O157:H7 Selective Agar plates.

Prior to inoculation dumplings from Groups A-D were unpacked onto a tray, exposed to UV light in a biohood for 15 minutes, turned over and exposed for an additional 15 minutes and removed from the original packages onto a sterile surface inside a laminar flow bio-safety hood. 20 micro liters of the E. coli. O157:H7 suspension was inoculated onto the surface of each dumpling. Inoculated dumplings were incubated at ambient temperature for 15 minutes to allow attachment. Dumplings were individually packed and sealed in zip-lock bags and incubated at room temperature (22-25° C.) for up to 72 hours.

Three samples from each group were removed after 3 hours, 24 hours, 48 hours, and 72 hours for microbiologic evaluation. Each sample was opened and 10 ml of 0.1% sterile peptone water was added to each bag. Each bag was shaken vigorously 100 times. Colony forming units (CFU) per dumpling were determined by serial dilution of an aliquot from each dumpling and plating on E. coli. O157:H7 Selective Agar plates. After plating, all plates were incubated at 37° C. for about 48 hours before CFU determination. Log reductions were calculated with regard to control Group A. The results are shown in Tables 3.1-3.4 below.

TABLE 3.1
After 3 hours

| | | CFU/ | \overline{A} of CFU/ | \overline{A} Log | Log |
|---|---|---|---|---|---|
| Group | ε-PL (ppm) | dumpling | dumpling¹ | Value | Reduction |
| A | 0 | 5.53E+03 | 5.05E+03 | 3.70 | — |
| | | 6.19E+03 | | | |
| | | 3.42E+03 | | | |
| B | 1000 | 3.60E+03 | 2.25E+03 | 3.35 | 0.35 |
| | | 2.03E+03 | | | |
| | | 1.11E+03 | | | |
| C | 2000 | 4.00E+01 | 1.13E+02 | 2.05 | 1.65 |
| | | 6.00E+01 | | | |
| | | 2.40E+02 | | | |
| D | 3000 | 1.00E+01 | 5.33E+01 | 1.73 | 1.98 |
| | | 2.00E+01 | | | |
| | | 1.30E+02 | | | |

¹Detection limit of 1.00E+01 CFU/dumpling.

TABLE 3.2
After 24 hours

| | | CFU/ | \overline{A} of CFU/ | \overline{A} Log | Log |
|---|---|---|---|---|---|
| Group | ε-PL (ppm) | dumpling | dumpling¹ | Value | Reduction |
| A | 0 | 6.57E+08 | 7.95E+08 | 8.90 | — |
| | | 8.23E+08 | | | |
| | | 9.05E+08 | | | |
| B | 1000 | 1.84E+06 | 3.61E+06 | 6.56 | 2.34 |
| | | 7.53E+05 | | | |
| | | 8.25E+06 | | | |
| C | 2000 | 7.80E+02 | <2.64E+02 | <2.42 | >6.48 |
| | | <1.00E+01 | | | |
| | | <1.00E+00 | | | |
| D | 3000 | <1.00E+01 | <4.97E+02 | <2.70 | >6.20 |
| | | 1.47E+03 | | | |
| | | <1.00E+01 | | | |

¹Detection limit of 1.00E+01 CFU/dumpling.

TABLE 3.3
After 48 hours

| | | CFU/ | \overline{A} of CFU/ | \overline{A} Log | Log |
|---|---|---|---|---|---|
| Group | ε-PL (ppm) | dumpling | dumpling¹ | Value | Reduction |
| A | 0 | 5.53E+09 | 5.11E+09 | 9.71 | — |
| | | 5.13E+09 | | | |
| | | 4.67E+09 | | | |
| B | 1000 | 1.80E+06 | 6.51E+07 | 7.81 | 1.89 |
| | | 8.67E+07 | | | |
| | | 9.07E+07 | | | |
| C | 2000 | 8.53E+05 | >4.61E+05 | >5.66 | <4.05 |
| | | >5.00E+05 | | | |
| | | 2.89E+04 | | | |
| D | 3000 | <1.00E+01 | <1.00E+01 | <1.00 | >8.71 |
| | | <1.00E+01 | | | |
| | | <1.00E+01 | | | |

¹Detection limit of 1.00E+01 CFU/dumpling.

TABLE 3.4
After 72 hours

| | | CFU/ | \overline{A} of CFU/ | \overline{A} Log | Log |
|---|---|---|---|---|---|
| Group | ε-PL (ppm) | dumpling | dumpling¹ | Value | Reduction |
| A | 0 | 6.53E+09 | 7.15E+09 | 9.85 | — |
| | | 6.93E+09 | | | |
| | | 8.00E+09 | | | |
| B | 1000 | 1.60E+08 | 1.74E+08 | 8.24 | 1.61 |
| | | 3.44E+08 | | | |
| | | 1.73E+07 | | | |
| C | 2000 | <2.00E+03 | <3.33E+04 | <4.52 | >5.33 |
| | | 8.20E+04 | | | |
| | | 1.60E+04 | | | |
| D | 3000 | <1.00E+01 | <1.00E+01 | <1.00 | >8.85 |
| | | <1.00E+01 | | | |
| | | <1.00E+01 | | | |

¹Detection limit of 1.00E+01 CFU/dumpling.

As can be seen from Tables 3.1-3.4, the addition of ε-PL to the flour portion of the dumpling completely suppressed replication of E. coli O157:H7 when added at a final concentration of 3000 ppm. At 3000 ppm, ε-PL totally prevented replication of E. coli O157:H7 and killed more than 2 logs of the bacteria. The E. coli O157:H7 inoculation level was 6.0×10³ CFU/dumpling. This post-lethality effect was evident at 3 hours post-inoculation.

### EXAMPLE 14

### Effects of Food Additive Composition on Listeria monocytogenes in Dough

Four portions of dumpling dough were prepared by blending 200 g of all purpose wheat flour with 113 g of water and varying amounts of ε-polylysine (“ε-PL”), to create four different groups. Group A was untreated and served as a control. Group B was mixed with 524 g of ε-polylysine, Group C was mixed with 1248 g of ε-polylysine, and Group D was mixed with 1872 g of ε-polylysine. Final concentrations of ε-polylysine within Groups B-D were:

| Group | ε-Polylysine Concentration |
|---|---|
| B | 1000 ppm |
| C | 2000 ppm |
| D | 3000 ppm |

Each group of dough formulations was divided into 30 pieces each, and the pieces were rolled flat to make 30 flat pieces, each about 1.5″ in diameter and 0.25″ thick. The uncooked dumplings were placed in boiling water and boiled until all the dumplings floated. The dumplings were removed, and the excess water was briefly drained. The dumplings were cooled to room temperature in a sterilized tray.

Five strains of Listeria monocytogenes were cultured separately at 10° C. They were cold adapted for 6 days and mixed in equal proportions just before use. The mixture was further diluted to a final concentration of 2.68×10³ cfu/20 micro liters. Inoculation level was determined after the fact by removing an aliquot of the mixture, making a serial dilution and plating serial dilutions onto Listeria Selective Agar plates. 20 micro liters of the Listeria suspension was inoculated onto the surface of one side of each dumpling sheet. Inoculated dumpling sheets were incubated at ambient temperature for 30 minutes to allow attachment. Dumpling sheets were individually packed and vacuum sealed. Dumpling sheets were incubated at 10° C.

Three samples from each group were removed after 1 hours and 24 hours for microbiologic evaluation. Each sample was opened and 10 ml of 0.1% sterile peptone water was added to each bag. Each bag was shaken vigorously 100 times. Colony forming units (CFU) per dumpling were determined by serial dilution of an aliquot from each dumpling and plating on Listeria Selective Agar plates. After plating, all plates were incubated at 37° C. for about 48 hours before CFU determination. Log reductions were calculated with regard to control Group A. The results are shown in Tables 4.1-4.2 below.

TABLE 4.1
After 1 hour

| | | CFU/ | \overline{A} of CFU/ | \overline{A} Log | Log |
|---|---|---|---|---|---|
| Group | ε-PL (ppm) | dumpling | dumpling¹ | Value | Reduction |
| A | 0 | 2.30E+03 | 2.55E+03 | 3.14 | — |
| | | 2.64E+03 | | | |
| | | 2.70E+03 | | | |
| B | 1000 | 2.00E+02 | 3.27E+02 | 2.15 | 0.89 |
| | | 3.80E+02 | | | |
| | | 4.00E+02 | | | |
| C | 2000 | <1.00E+01 | <1.00E+01 | <1.00 | >2.41 |
| | | <1.00E+01 | | | |
| | | <1.00E+01 | | | |
| D | 3000 | <1.00E+01 | <1.00E+01 | <1.00 | >2.41 |
| | | <1.00E+01 | | | |
| | | <1.00E+01 | | | |

¹Detection limit of 10 CFU/dumpling.

TABLE 4.2
After 24 hours

| | | CFU/ | \overline{A} of CFU/ | \overline{A} Log | Log |
|---|---|---|---|---|---|
| Group | ε-PL (ppm) | dumpling | dumpling¹ | Value | Reduction |
| A | 0 | 4.82E+03 | 5.48E+04 | 4.74 | — |
| | | 4.97E+04 | | | |
| | | 1.10E+05 | | | |
| B | 1000 | 2.10E+02 | 2.10E+02 | 2.32 | 2.42 |
| | | 1.30E+02 | | | |
| | | 2.90E+02 | | | |
| C | 2000 | <1.00E+01 | <1.00E+01 | <1.00 | >3.74 |
| | | <1.00E+01 | | | |
| | | <1.00E+01 | | | |
| D | 3000 | <1.00E+01 | <1.00E+01 | <1.00 | >3.74 |
| | | <1.00E+01 | | | |
| | | <1.00E+01 | | | |

¹Detection limit of 10 CFU/dumpling.

As can be seen from Tables 4.1-4.2, the addition of ε-PL to the flour portion of the dumpling completely suppressed replication of Listeria monocytogenes when added at a final concentration of 1000-3000 ppm. At 2000 ppm and above the addition of ε-PL not only prevented replication of Listeria monocytogenes, it also caused a post-lethality effect, i.e., the ε-PL killed the Listeria down to the limits of detection (10 CFU/piece). ε-PL appears to be more effective in a flour matrix than when it is added directly to ground meat or poultry products, because studies have shown it takes as much as 3000 ppm to achieve a post-lethality effect and outgrowth control for turkey meat inoculated with Listeria.

### EXAMPLE 10

### Effects of Food Additive Composition Containing Polylysine and Acidic Adjuvant on E. coli in Ground Meat

A mixture of ground beef was prepared by mixing irradiated ground beef (Huisken Meats, Sauk Rapids, Minn.) having 7.73% fat content with irradiated ground beef (Huisken) having 24.78% fat content, to give a final mixture having 20% fat content. The ground beef mixture was divided into five groups, Groups A-E, of 100 g each. Each group was mixed with 1.4 mL of a different combination of deionized water (“DH₂O”), AGIIS, lactic acid, and ε-polylysine (“ε-PL”) according to the following table:

| Group | Additive Composition | Final meat pH | Meat Composition |
|---|---|---|---|
| A | 100% DH₂O | 6.20 | 1.38% DH₂O |
| B | 4.29% 5 N AGIIS | 5.69 | 0.059% 5 N AGIIS |
| | 10% lactic acid | | 0.138% lactic acid |
| | 85.71% DH₂O | | 1.18% DH₂O |
| C | 40% 5 N AGIIS | 5.08 | 0.552% 5 N AGIIS |
| | 10% lactic acid | | 0.138% lactic acid |
| | 50% DH₂O | | 0.69% DH₂O |
| D | 0.6 g ε-PL | 6.64 | 1.38% DH₂O |
| | DH₂O | | 3000 ppm ε-PL |
| E | 40% 5 N AGIIS | 5.52 | 0.552% 5 N AGIIS |
| | 10% lactic acid | | 0.138% lactic acid |
| | 50% DH₂O | | 0.69% DH₂O |
| | 0.6 g ε-PL | | 3000 ppm ε-PL |

Five strains of E. coli O157:H7 were cultured separately in E. coli enrichment broth overnight at 37° C. in a shaking water bath. The cultures were mixed in equal proportions just before use. The mixture was further diluted 1:10,000 with sterile saline solution to produce a strain suspension for inoculation. 0.4 mL of E. coli suspension was hand mixed into each group of the ground beef samples. Each group of ground beef was then distributed into 12 sterilized test tubes (50 mL, Falcon, BD Biosciences, Franklin Lakes, N.J.), with each tube containing 5 g of sample. Each test tube was loosely covered with its lid and stored at room temperature.

The determination of E. coli presence in the samples was performed immediately, then after 1, 2, and 3 days. Three tubes from each group were removed for microbiologic evaluation. 10 ml of 0.1 % sterile peptone water was added to each tube, and the tube was shaken vigorously to evenly distribute the meat. Colony forming units (CFU) per tube were determined by serial dilution of an aliquot from each tube and plating on E. coli. O157:H7 Selective Agar plates. After plating, all plates were incubated at 37° C. for about 40 to 48 hours before CFU determination. Log reductions were calculated with regard to control Group A. The results are shown in Tables 5.1-5.4 below.

TABLE 5.1
Initial Determination

| Group | CFU/g | \overline{A} of CFU/g¹ | \overline{A} Log Value | Log Reduction |
|---|---|---|---|---|
| A | 2.82E+02 | 2.98E+02 | 2.47 | — |
| | 3.04E+02 | | | |
| | 3.08E+02 | | | |
| B | 3.20E+02 | 2.75E+02 | 2.44 | 0.03 |
| | 2.58E+02 | | | |
| | 2.46E+02 | | | |
| C | 1.70E+02 | 2.10E+02 | 2.32 | 0.15 |
| | 2.58E+02 | | | |
| | 2.02E+02 | | | |
| D | 7.20E+01 | 4.00E+01 | 1.60 | 0.87 |
| | 2.80E+01 | | | |
| | 2.00E+01 | | | |
| E | 1.80E+01 | 1.07E+01 | 1.03 | 1.44 |
| | 4.00E+00 | | | |
| | 1.00E+01 | | | |

TABLE 5.2
After 1 day

| Group | CFU/g | \overline{A} of CFU/g¹ | \overline{A} Log Value | Log Reduction |
|---|---|---|---|---|
| A | >1.00E+05 | >1.00E+05 | >5.00 | — |
| | >1.00E+05 | | | |
| | >1.00E+05 | | | |
| B | >1.00E+05 | >1.00E+05 | >5.00 | — |
| | >1.00E+05 | | | |
| | >1.00E+05 | | | |
| C | 2.64E+04 | 1.75E+04 | 4.24 | >0.76 |
| | 2.28E+04 | | | |
| | 3.28E+03 | | | |
| D | <2.00E+00 | <2.20E+03 | <3.34 | >1.66 |
| | 7.20E+01 | | | |
| | 6.52E+03 | | | |
| E | <2.00E+00 | <2.00E+00 | <0.30 | >4.70 |
| | 2.00E+00 | | | |
| | <2.00E+00 | | | |

TABLE 5.3
After 2 days

| Group | CFU/g | \overline{A} of CFU/g¹ | \overline{A} Log Value | Log Reduction |
|---|---|---|---|---|
| A | 7.00E+09 | 6.40E+09 | 9.81 | — |
| | 5.11E+09 | | | |
| | 7.08E+09 | | | |
| B | 2.95E+09 | 3.35E+09 | 9.53 | 0.28 |
| | 3.84E+09 | | | |
| | 3.27E+09 | | | |
| C | 1.26E+06 | 1.11E+06 | 6.05 | 3.76 |
| | 8.44E+05 | | | |
| | 1.22E+06 | | | |
| D | 2.13E+03 | 1.24E+04 | 4.09 | 5.72 |
| | 1.30E+03 | | | |
| | 3.37E+04 | | | |
| E | 4.00E+00 | 1.33E+00 | 0.43 | 9.38 |
| | 2.00E+00 | | | |
| | 2.00E+00 | | | |

TABLE 5.4
After 3 days

| Group | CFU/g | \overline{A} of CFU/g¹ | \overline{A} Log Value | Log Reduction |
|---|---|---|---|---|
| A | 1.05E+10 | 1.02E+10 | 10.01 | — |
| | 9.32E+09 | | | |
| | 1.07E+10 | | | |
| B | 6.23E+09 | 7.45E+09 | 9.87 | 0.14 |
| | 8.53E+09 | | | |
| | 7.59E+09 | | | |
| C | 6.15E+05 | 4.90E+06 | 6.69 | 3.32 |
| | 1.21E+07 | | | |
| | 1.96E+06 | | | |
| D | 9.67E+05 | 1.42E+06 | 6.15 | 3.86 |
| | 3.28E+06 | | | |
| | 3.85E+03 | | | |
| E | <2.00E+00 | <2.00E+00 | <0.30 | >9.71 |
| | <2.00E+00 | | | |
| | <2.00E+00 | | | |

The results indicate that acidulation of meat to a level of pH 5.69 is ineffective in controlling replication of E. coli O157:H7 replication, whereas acidulation to pH 5.08 did in fact suppress replication of E. coli O157:H7 significantly. However, lowering the pH to 5.08 brought about reduction of myoglobin, thereby presenting organoleptic and textural problems. Addition of 3000 ppm of ε-PL by itself suppressed E. coli O157:H7 replication to nearly the same level as acidulation to 5.08, but as can be seen from Table 5.4, acidulation with AGIIS and lactic acid to a final pH of 5.52 along with the addition of 3000 ppm of ε-PL dramatically enhanced the antimicrobial effect. In addition, organoleptic changes due to acidulation were eliminated.

### REFERENCES CITED

The content of each of the U.S. patent documents and publications listed below is hereby incorporated by reference.

### U.S. PATENT DOCUMENTS

U.S. Patent No. 5,900,363
U.S. Patent No. 6,436,891
U.S. Patent No. 6,572,908
U.S. patent application Ser. No. 09/873,755
U.S. patent application Ser. No. 09/500,473
U.S. patent application Ser. No. 09/655,131

### OTHER PUBLICATIONS

Boich, E. and Arinder, P. Bacteriological safety issues in red meat and ready-to-eat meat products, as well as control measures. Meat Sci., 62: 381-90 (2002).
Conner, D. Microbial Pathogens of Poultry: Processing Plant Considerations, Poultry Meat Processing, CRC Press, LLC, A. R. Sams, ed. (2001).
Hiraki, J. ε-Polylysine; its development and utilization. Fine Chemicals. 29: 18-25 (2000).
Huffman, R. D. Current and future technologies for the decontamination of carcasses and fresh meat. Meat Sci., 62: 285-94 (2002).
Mermelstein, N. H. Sanitizing meat. Food Technol., 55(3): 64-68 (2001).
Neda, K., Sakurai, T., Takahashi, M., Aiuchi, M., Ohgushi, M. Two-generation reproduction study with teratology test of ε-poly-L-lysine by dietary administration in rats. Jpn. Pharmacol. Ther. 27: 1139-59 (1999).
Shima, S., Matsuoka, H., Iwamoto, T., Sakai, H. Antimicrobial action of ε-poly-L-lysine. J. Antibiotics. 37: 1449-55 (1984).
White, R. USDA takes aim at a deadly microbe. Food Quality, 9(6): 6-7 (2002).
Yoshida, T., Hiraki, J., Nagasawa, T. Polyamides and Complex Proteinaceous Materials I. Biopolymer. 7: 107-21 (2002).

What is claimed is:

1. A food additive composition comprising:
ε-polylysine in an amount ranging from about 100 ppm to about 10,000 ppm; and with or without an acidic adjuvant.

2. The food additive composition of claim 1, wherein the acidic adjuvant comprises a low pH solution of sparingly-soluble Group IIA-complexes (“AGIIS”), a highly acidic metalated organic acid (“HAMO”), or a highly acidic metalated mixture of inorganic acids (“HAMMIA”).

3. The food additive composition of claim 2, wherein the acidic adjuvant further comprises one or more additives.

4. The food additive composition of claim 3, wherein the one or more additives comprises one or more organic acids.

5. The food additive composition of claim 4, wherein the one or more organic acids are selected from the group consisting of lactic acid, propionic acid, acetic acid, maleic acid, tartaric acid, and a mixture thereof.

6. The food additive composition of claim 3, wherein the one or more additives comprises one or more amino acids, alcohols, or surfactants.

7. The food additive composition of claim 1, wherein the amount of the ε-polylysine ranges from about 1000 to about 6000 ppm.

8. The food additive composition of claim 1, wherein the amount of the ε-polylysine ranges from about 3000 to about 4000 ppm.

9. A method for reducing pathogenic microorganisms in a food product comprising:
blending the food product with a food additive composition, wherein the food additive composition comprises:
ε-polylysine in an amount ranging from about 100 ppm to about 10,000 ppm; and
an acidic adjuvant.

10. The method of claim 9, wherein the acidic adjuvant comprises a low pH solution of sparingly-soluble Group IIA-complexes (“AGIIS”), a highly acidic metalated organic acid (“HAMO”), or a highly acidic metalated mixture of inorganic acids (“HAMMIA”).

11. The method of claim 10, wherein the acidic adjuvant further comprises one or more additives.

12. The method of claim 11, wherein the one or more additives comprises one or more organic acids.

13. The method of claim 12, wherein the one or more organic acids are selected from the group consisting of lactic acid, propionic acid, acetic acid, maleic acid, tartaric acid, and a mixture thereof.

14. The method of claim 11, wherein the one or more additives comprises one or more amino acids, alcohols, or surfactants.

15. The method of claim 9, wherein the amount of the ε-polylysine ranges from about 1000 to about 6000 ppm.

16. The method of claim 9, wherein the amount of the ε-polylysine ranges from about 3000 to about 4000 ppm.

17. The method of claim 9, wherein the food product is a ground meat product.

18. The method of claim 9, wherein the food product is a cooked meat product.

19. The method of claim 9, wherein the food product is a flour-based dough product.

20. The method of claim 9, wherein the pathogenic microorganisms are Gram negative bacteria.

21. The method of claim 20, wherein the pathogenic microorganisms are E. coli or Salmonella.

22. The method of claim 9, wherein the pathogenic microorganisms are Gram positive bacteria.

23. The method of claim 22, wherein the pathogenic microorganisms are Listeria monocytogenes.

24. A method for reducing pathogenic microorganisms in a food product comprising:
blending the food product with a food additive composition, wherein the food additive composition comprises:
ε-polylysine in an amount ranging from about 100 ppm to about 10,000 ppm.

25. The method of claim 24, wherein the amount of the ε-polylysine ranges from about 1000 to about 6000 ppm.

26. The method of claim 24, wherein the amount of the ε-polylysine ranges from about 3000 to about 4000 ppm.

27. The method of claim 24, wherein the food product is a ground meat product.

28. The method of claim 24, wherein the food product is a cooked meat product.

29. The method of claim 24, wherein the food product is a flour-based dough product.

30. The method of claim 24, wherein the pathogenic microorganisms are Gram negative bacteria.

31. The method of claim 30, wherein the pathogenic microorganisms are E. coli or Salmonella.

32. The method of claim 24, wherein the pathogenic microorganisms are Gram positive bacteria.

33. The method of claim 32, wherein the pathogenic microorganisms are Listeria monocytogenes.

34. A method for reducing Gram negative and Gram positive bacterial microorganisms in a flour-based food product comprising:
blending the food product with a food additive composition, wherein the food additive composition comprises:
ε-polylysine in an amount ranging from about 100 ppm to about 10,000 ppm.

35. The method of claim 34, wherein the amount of the ε-polylysine ranges from about 1000 to about 6000 ppm.

36. The method of claim 34, wherein the amount of the ε-polylysine ranges from about 3000 to about 4000 ppm.

37. A method for reducing Gram negative and Gram positive bacterial microorganisms in a ground meat product comprising:
blending the food product with a food additive composition, wherein the food additive composition comprises:
ε-polylysine in an amount ranging from about 100 ppm to about 10,000 ppm; and
an acidic adjuvant.

38. The method of claim 37, wherein the acidic adjuvant comprises a low pH solution of sparingly-soluble Group IIA-complexes (“AGIIS”), a highly acidic metalated organic acid (“HAMO”), or a highly acidic metalated mixture of inorganic acids (“HAMMIA”).

39. The method of claim 38, wherein the acidic adjuvant further comprises one or more additives.

40. The method of claim 39, wherein the one or more additives comprises one or more organic acids.

41. The method of claim 40, wherein the one or more organic acids are selected from the group consisting of lactic acid, propionic acid, acetic acid, maleic acid, tartaric acid, and a mixture thereof.

42. The method of claim 39, wherein the one or more additives comprises one or more amino acids, alcohols, or surfactants.

43. The method of claim 38, wherein the amount of the ε-polylysine ranges from about 1000 to about 6000 ppm.

44. The method of claim 38, wherein the amount of the ε-polylysine ranges from about 3000 to about 4000 ppm.
